(19) United States
(12) Patent Application Publication
(10) Pub. No.: US 2007/0099690 A1
(43) Pub. Date: May 3, 2007

(54) Gaming machine

(75) Inventors: Takashi Nozaki, Tokyo (JP); Kuniaki Honno, Tokyo (JP); Shinya Ando, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/371,162

(22) Filed: Mar. 9, 2006

(30) Foreign Application Priority Data
Oct. 28, 2005 (JP) 2005-315105

(51) Int. Cl. A63F 13/00

(52) U.S. Cl. 463/20

(57) ABSTRACT

Disclosed is a gaming machine. According to the gaming machine, when the detection of the stop operation is carried out, the number of sliding symbols is obtained on the basis of the symbol specified by the symbol specifying means and the stop table and the highest priority attraction-in ranking is determined among a the predetermined number of symbols from the symbols specified by the symbol specifying means, on the basis of the internal winning combination determined. In addition, when a priority attraction-in ranking of the symbol based on the number of sliding symbols obtained is same as the priority attraction-in ranking determined to be highest, the rotation of reel is stopped on the basis of the number of sliding symbols obtained, and when it is not same, the rotation of reel is stopped on the basis of the number of sliding symbols corresponding to the symbol having the priority attraction-in ranking determined to be highest.

### CROSS REFERENCE TO RELATED APPLICATION

This application is based upon and claims the benefit of priority from the prior Japanese Patent Application No. 2005-315105 filed on Oct. 28, 2005.

### BACKGROUND OF THE INVENTION

1. Field of the Invention

The present invention relates to a gaming machine.

2. Description of Related Art

It has been conventionally known a gaming machine, so-called, pachi-slot machine comprising a plurality of reels, each of which having plural symbols arranged on a periphery thereof; plural display windows mounted to correspond to each of the reels and displaying some of the plural symbols arranged on the periphery of each reel so as to allow a player to see them; a start switch for outputting a signal requiring start of rotation of each reel, based on an operation by the player (hereinafter, referred to as “start operation”), on condition that a medal has been inserted; a stop switch for outputting a signal requiring stop of the rotation of the corresponding reel, correspondingly to types of the reels, based on an operation by the player (hereinafter, referred to as “stop operation”); a control unit for controlling an operation of a stepping motor to rotate and stop the respective reels, based on the signals outputted from the start switch and the stop switch. In the pachi-slot machine, based on combinations of the symbols displayed by the plural display windows, it is determined whether a winning is achieved or not. If it is determined that the winning is achieved, a medal is paid out.

At present time, in the pachi-slot machine forming the mainstream, if the start operation by the player is detected, an internal lottery is carried out, and the rotation of reel is stopped on the basis of the lottery result and the timing of the stop operation by the player. For example, if a result relating to a winning is determined by the internal lottery (hereinafter, a type of the internal lottery result will be referred to as “internal winning combination”), the reel continues to rotate within a predetermined period (for example, 190 ms) and then stops so that the corresponding winning is made, even after the stop operation is carried out by the player. In addition, if the internal winning combination relating to the winning is not determined, the rotation of reel is stopped so that a winning is not achieved.

In addition, in recent years, as disclosed in a Japanese Patent Laid-Open No. Hei11-9765, it is suggested a pachi-slot machine comprising a plurality of tables (hereinafter, referred to as “stop table”) defining a rotation amount (also referred to as “number of sliding symbols”) of a reel from after a stop operation is carried out by a player until the reel rotation is stopped, wherein the reel rotation is stopped, based on a selected stop table. According to the pachi-slot to the pachi-slot machine having many stop tables, the combinations of symbols displayed by the plural display windows becomes more various.

However, according to the conventional pachi-slot machines, in case that there is provided a stop table defining the inappropriate number of sliding symbols, the rotation of reel is stopped on the basis of the corresponding number of sliding symbols. Accordingly, even though an internal winning combination relating to a winning is not determined, the winning is achieved and a player's skill is not properly reflected. It would be a burden for a manufacturer of the gaming machine to prepare a stop table which does not cause the above problems and to check the stop table.

### SUMMARY OF THE INVENTION

Accordingly, the invention has been made to solve the above-mentioned problems occurring in the prior art. An object of the invention is to provide a gaming machine capable of allowing an inappropriate number of sliding symbols not to be determined, thereby properly reflecting a result of an internal lottery and a player's skill.

In order to achieve the above object, there is provided a gaming machine comprising a reel having a plurality of symbols arranged on a periphery thereof and displaying the plural symbols; start operation detection means for detecting a start operation; internal winning combination determination means for determining an internal winning combination, on the basis of the detection of the start operation carried out by the start operation detection means; reel rotation means for rotating the reel; stop operation detection means for detecting a stop operation; symbol specifying means for specifying a symbol located on a predetermined position; stop table memory means for memorizing a stop table defining the number of sliding symbols for each of symbols arranged on the periphery of the reel; means for obtaining the number of sliding symbols, on the basis of the symbol specified by the symbol specifying means and the stop table memorized by the stop table memory means, when the detection of the stop operation is carried out by the stop operation detection means; priority ranking determination means for determining the highest priority attraction-in ranking among a predetermined number of symbols from the symbols specified by the symbol specifying means, on the basis of the internal winning combination determined by the internal winning combination means, when the detection of the stop operation is carried out by the stop operation detection means; and reel stop means for stopping the rotation of reel on the basis of the number of sliding symbols obtained by the means for obtaining the number of sliding symbols, when a priority attraction-in ranking of the symbol based on the number of sliding symbols obtained by the means for obtaining the number of sliding symbols is same as the priority attraction-in ranking determined by the priority ranking determination means, and for stopping the rotation of reel on the basis of the number of sliding symbols corresponding to the symbol of the priority attraction-in ranking determined by the priority ranking determination means, when a priority attraction-in ranking of the symbol based on the number of sliding symbols obtained by the means for obtaining the number of sliding symbols is not same as the priority attraction-in ranking determined by the priority ranking determination means.

According to the above gaming machine, if the detection of the stop operation is carried out, the number of sliding symbols is obtained on the basis of the symbol specified by the symbol specifying means and the stop table. In addition, the highest priority attraction-in ranking among the predetermined number of symbols is determined from the symbols specified by the symbol specifying means, on the basis of the determined internal winning combination. In case that a priority attraction-in ranking of the symbol based on the number of sliding symbols obtained is same as the priority attraction-in ranking determined to be highest, the rotation of reel is stopped, based on the number of sliding symbols obtained. In case of not being same, the rotation of reel is stopped on the basis of the number of sliding symbols corresponding to the symbol of the priority attraction-in ranking determined to be highest. In other words, even when the priority attraction-in ranking of the symbol based on the number of sliding symbols defined in the stop table is not highest, the rotation of reel can be stopped on the basis of the number of sliding symbols corresponding to the symbol of the highest priority attraction-in ranking. Accordingly, it is possible to check whether the number of sliding symbols obtained on the basis of the stop table is inappropriate or not and to allow the inappropriate number of sliding symbols not to be determined. As a result of that, it is possible to properly reflect the lottery result or a player's skill.

In addition, even when the number of sliding symbols defined in the stop table is inappropriate, since it is allowed, it is possible to reduce a development burden of checking a stop table prepared.

Herein, the “number of sliding symbols” is a rotation amount of a reel from after the detection of the stop operation is carried out by the stop operation detection means until the rotation of reel is stopped. In other words, it is the number of symbols passing through a predetermined position from the symbol specified by the symbol specifying means, until the rotation of reel is stopped, when the detection of the stop operation is carried out by the stop operation detection means.

According to the invention, the gaming machine may further comprise means for memorizing a retrieval order table defining a retrieval order in accordance with each number of sliding symbols of a predetermined range, based on the number of sliding symbols defined by the stop table. The means for obtaining the number of sliding symbols obtains the number of sliding symbols on the basis of the symbol specified by the symbol specifying means, the stop table memorized by the stop table memory means and the retrieval order table memorized by the retrieval order table memory means, when the detection of the stop operation is carried out by the stop operation detection means, and the retrieval order table defines a retrieval order of the number of sliding symbols defined by the stop table to be highest.

According to the above gaming machine, it is obtained the number of sliding symbols on the basis of the symbol specified by the symbol specifying means, the stop table and the retrieval order table, when the detection of the stop operation is carried out. The retrieval order table is structured in such a way that it defines a retrieval order in correspondence with each number of sliding symbols of a predetermined range, based on the number of sliding symbols defined by the stop table. In other words, it is obtained each number of sliding symbols of the predetermined range, according to the retrieval order based on the number of sliding symbols defined by the stop table. Therefore, even when there are plural same priority attraction-in rankings in the symbols based on the number of sliding symbols of the predetermined range including the number of sliding symbols defined by the stop table, it is possible to stop the rotation of reel on the basis of a single number of sliding symbols having a higher retrieval order.

In addition, the retrieval order table defines the retrieval order of the number of sling symbols defined by the stop table to be highest. In other words, the number of sliding symbols defined by the stop table is preferentially obtained. Accordingly, if the priority attraction-in ranking of the symbol based on the number of sliding symbols defined by the stop table is same as the highest priority attraction-in ranking, even when the number of sliding symbols having a same attraction-in order as it exists within the predetermined range, it is possible to stop the rotation of reel on the basis of the number of sliding symbols defined by the stop table. As a result of that, it is possible to preferentially display a symbol intended in the development.

According to the invention, the gaming machine may further comprise maximum possible number of sliding symbols determination means for determining the number of sliding symbols at which a display of a symbol relating to the internal winning combination determined by the internal winning combination determination means is obstructed, among the number of sliding symbols of the predetermined range, as a maximum possible number of sliding symbols, when the detection of the stop operation is carried out by the stop operation detection means. The reel stop means may stop the rotation of reel on the basis of the number of sliding symbols obtained by the means for obtaining the number of sliding symbols, in case that the priority attraction-in ranking of the symbol based on the number of sliding symbols obtained by the means for obtaining the number of sliding symbols is same as the priority attraction-in ranking determined by the priority ranking determination means and the number of sliding symbols obtained by the means for obtaining the number of sliding symbols is smaller than the maximum possible number of sliding symbols determined by the maximum possible number of sliding symbols determination means.

According to the above gaming machine, when the detection of the stop operation is carried out, the number of sliding symbols at which the display of a symbol relating to the internal winning combination, among the number of sliding symbols of the predetermined range, is obstructed, is determined as the maximum possible number of sliding symbols. In case that the priority attraction-in ranking of the symbol based on the number of sliding symbols obtained is same as the priority attraction-in ranking determined to be highest and the number of sliding symbols obtained is smaller than the maximum possible number of sliding symbols, the rotation of reel is stopped on the basis of the number of sliding symbols obtained. In other words, it is checked whether or not the number of sliding symbols determined to have the highest priority attraction-in ranking of symbol is the number of sliding symbols at which the display of a symbol relating to the internal winning combination is obstructed. If it is not the number of sliding symbols at which the display of a symbol relating to the internal winning combination is obstructed, the rotation of reel is stopped on the basis of the corresponding number of sliding symbols. Accordingly, even though the priority attraction-in ranking of the symbol based on the number of sliding symbols obtained is the number of sliding symbols determined to have the highest priority attraction-in ranking of symbol, if the display of a symbol relating to the internal winning combination is obstructed, it is not determined. As a result of that, it is possible to prevent the display of the symbol relating to the internal winning combination from being obstructed.

Herein, “the obstruction of the display of symbol relating to the internal winning combination determined by the internal winning combination determination means” is meant as follows: for example, in case that plural internal winning combinations are determined, when there are the number of sliding symbols capable of displaying the symbol relating to a one internal winning combination and the number of sliding symbols capable of displaying the symbol relating to another internal winning combination having the same priority attraction-in ranking as the symbol relating to the corresponding one internal winning combination, among the numbers of sliding symbols of the predetermined range, it is determined the greater number of sliding symbols from these numbers of sliding symbols and the rotation of reel is stopped on the basis of it. In other words, if it is determined the greater number of sliding symbols, when the detection of the stop operation is carried out, it is obstructed the display of a symbol nearer at the symbol specified by the symbol specifying means and it is relatively lowered the extent to which the timing of the stop operation by the player is reflected.

According to the invention, there is provided a gaming machine comprising a reel having a plurality of symbols arranged on a periphery thereof and displaying the plural symbols; start operation detection means for detecting a start operation; internal winning combination determination means for determining an internal winning combination, on the basis of the detection of the start operation carried out by the start operation detection means; reel rotation means for rotating the reel; stop operation detection means for detecting a stop operation; symbol specifying means for specifying a symbol located on a predetermined position; priority ranking determination means for determining the highest priority attraction-in ranking among a the predetermined number of symbols from the symbols specified by the symbol specifying means, on the basis of the internal winning combination determined by the internal winning combination means, when the detection of the stop operation is carried out by the stop operation detection means; maximum possible number of sliding symbols determination means for determining the number of sliding symbols at which a display of a symbol relating to the internal winning combination determined by the internal winning combination determination means, among the numbers of sliding symbols of a predetermined range, is obstructed, as the maximum possible number of sliding symbols, when the detection of the stop operation is carried out by the stop operation detection means; and means for obtaining one of the numbers of sliding symbols of the predetermined range, in accordance with a predetermined retrieval order, wherein when a priority attraction-in ranking of the symbol based on the number of sliding symbols obtained by the means for obtaining the number of sliding symbols is same as the priority attraction-in ranking determined by the priority ranking determination means and the number of sliding symbols obtained by the means for obtaining the number of sliding symbols is smaller than the maximum possible number of sliding symbols determined by the maximum possible number of sliding symbols determination means, the rotation of reel is stopped on the basis of the number of sliding symbols obtained by the means for obtaining the number of sliding symbols.

According to the above gaming machine, when the detection of the stop operation is carried out, it is determined the highest priority attraction-in ranking among the predetermined number of symbols from the symbols specified by the symbol specifying means, on the basis of the determined internal winning combination, and the number of sliding symbols at which the display of a symbol relating to the internal winning combination, among the number of sliding symbols of the predetermined range, is obstructed, is determined as the maximum possible number of sliding symbols. One of the numbers of sliding symbols of the predetermined range is obtained according to a predetermined retrieval order and when the priority attraction-in ranking of the symbol based on the number of sliding symbols obtained is same as the priority attraction-in ranking determined to be highest and the number of sliding symbols obtained is smaller than the maximum possible number of sliding symbols, the rotation of reel is stopped on the basis of the number of sliding symbols obtained. In other words, it is checked whether or not the number of sliding symbols determined to have the highest priority attraction-in ranking of symbol is the number of sliding symbols at which the display of a symbol relating to the internal winning combination is obstructed. If it is not the number of sliding symbols at which the display of a symbol relating to the internal winning combination is obstructed, the rotation of reel is stopped on the basis of the corresponding number of sliding symbols. Accordingly, even though the priority attraction-in ranking of the symbol based on the number of sliding symbols obtained is the number of sliding symbols determined to have the highest priority attraction-in ranking of symbol, if the display of a symbol relating to the internal winning combination is obstructed, it is not determined. As a result of that, it is possible to prevent the display of the symbol relating to the internal winning combination from being obstructed. Therefore, it is possible to properly reflect the internal lottery result or a player's skill.

### BRIEF DESCRIPTION OF THE DRAWINGS

Other and further objects, features and advantages of the invention will appear more fully from the following description taken in connection with the accompanying drawings, in which:

FIG. 1 is a perspective view of schematically showing a gaming machine 1 according to an embodiment of the invention;

FIG. 2 is a view showing an example of symbols arranged on reels 3L, 3C, 3R;

FIG. 3 is a block diagram of an electric circuit of the gaming machine 1;

FIG. 4 is a view showing a symbol arrangement table of the gaming machine 1;

FIG. 5 shows a table for determining an internal lottery table of the gaming machine 1;

FIG. 6 is a view of showing an internal lottery table of the gaming machine 1;

FIG. 7 is a view of showing a table for determining an internal winning combination of the gaming machine 1;

FIG. 8 is a view of showing a table for determining a stop table of the gaming machine 1;

FIG. 9 shows a stop table of the gaming machine 1;

FIG. 10 is a view of showing a priority attraction-in ranking table of the gaming machine 1;

FIG. 11 is a view of showing a priority attraction-in ranking table of the gaming machine 1;

FIG. 12 shows a retrieval order table of the gaming machine 1;

FIG. 13 shows a symbol combination table of the gaming machine 1;

FIG. 14 shows an internal winning combination storing area in a RAM 33 of a main control circuit 71;

FIG. 15 shows an internal carryover combination storing area in a RAM 33 of a main control circuit 71;

FIG. 16 shows a symbol storing area in a RAM 33 of a main control circuit 71;

FIG. 17 shows an expected display combination storing area in a RAM 33 of a main control circuit 71;

FIG. 18 shows a corresponding table of a reel and an expected display combination storing area of a main control circuit 71;

FIG. 19 is a flow chart showing a reset-intervention process performed by a main control circuit 71;

FIG. 20 is a flow chart showing a medal receiving & start checking process by a main control circuit 71;

FIG. 21 is a flow chart showing an internal lottery process by a main control circuit 71;

FIG. 22 is a flow chart showing a reel stop initialization process by a main control circuit 71;

FIG. 23 is a flow chart showing an expected display combination storing process by a main control circuit 71;

FIG. 24 is a flow chart showing a display combination retrieving process by a main control circuit 71;

FIG. 25 is a flow chart showing an expected display combination state obtaining process by a main control circuit 71;

FIG. 26 is a flow chart following FIG. 25;

FIG. 27 is a flow chart showing a reel stop control process by a main control circuit 71;

FIG. 28 is a flow chart showing a priority attraction-in control process by a main control circuit 71;

FIG. 29 is a flow chart showing a control range retrieving process by a main control circuit 71;

FIG. 30 is a flow chart showing an intervention process having a period of 1.1173 msec by a main control circuit 71;

FIG. 31 shows a storing example of a symbol storing area in a RAM 33 of a main control circuit 71; and

FIG. 32 shows a storing example of an expected display combination storing area in a RAM 33 of a main control circuit 71.

### DESCRIPTION OF THE PREFERRED EMBODIMENTS

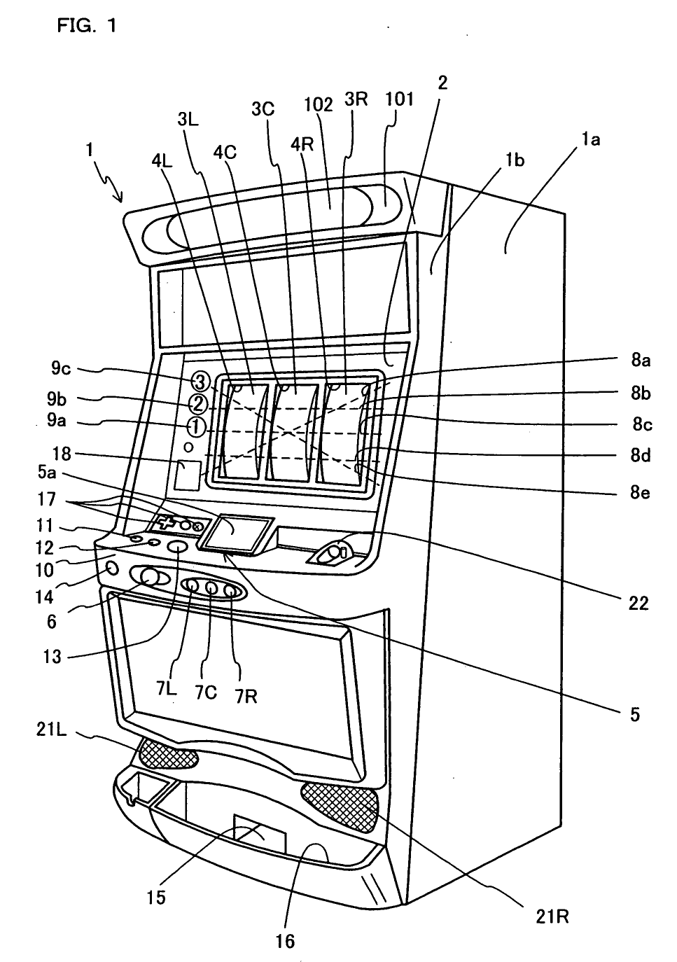

Hereinafter, it will be described a structure of a gaming machine 1 according to a preferred embodiment of the present invention with reference to the drawings. First, the gaming machine 1 is schematically described with reference to FIG. 1.

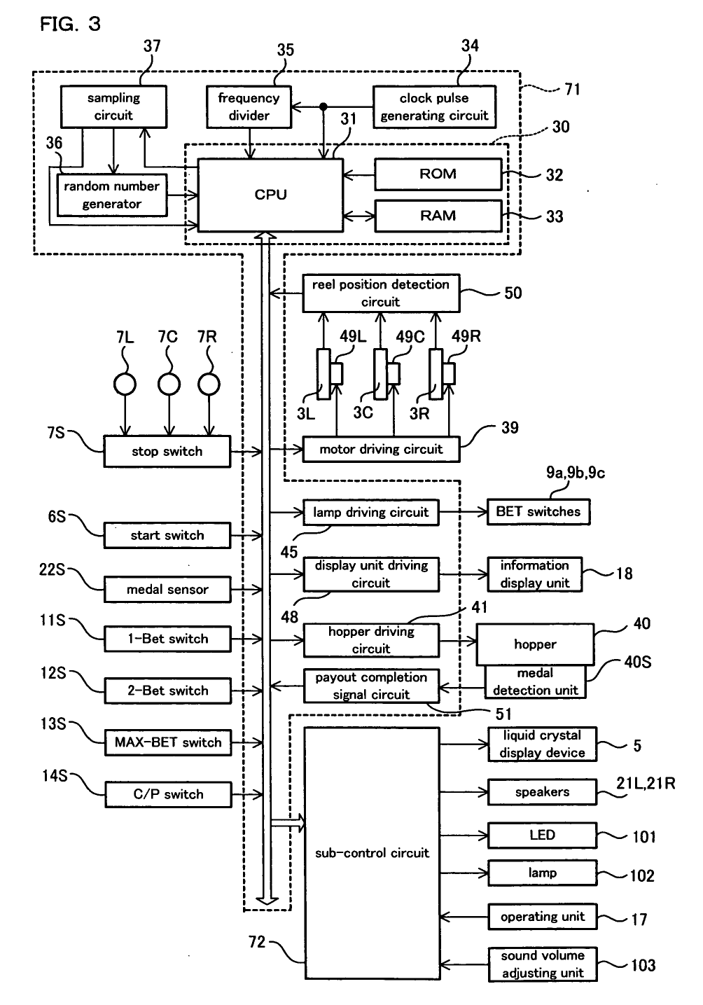

The gaming machine 1 comprises a cabinet 1a receiving reels 3L, 3C, 3R, a main control circuit 71 (see FIG. 3) and the like which will be described later, and a front door 1b which is mounted to be opened and closed with regard to the cabinet 1a.

The three reels 3L, 3C, 3R are horizontally mounted in a row in the cabinet 1a. In addition, plural symbols are continuously arranged in a rotation direction of the reel on a periphery of each of the reels 3L, 3C, 3R. Each of the reels 3L, 3C, 3R is controlled to rotate at a constant speed (for example, 80 revolutions/minute) by the main control circuit 71 which will be described later. The plural symbols arranged on the peripheries of the reels 3L, 3C, 3R are varied as the reels are rotated.

In addition, a panel display unit 2 having an approximately vertical surface is formed on the front door 1b. Three display windows 4L, 4C, 4R having a long rectangular shape are provided as symbol display areas to a center of the panel display unit 2. Each of the display windows 4L, 4C, 4R is mounted to be located at a front of each of the corresponding reels 3L, 3C, 3R. It is possible to observe the rotation and the rotation stop of the respective reels 3L, 3C, 3R through the display windows 4L, 4C, 4R. In addition, one symbol is respectively displayed on each display area of upper, center and lower parts of the respective display windows 4L, 4C, 4R and three symbols of the plural symbols arranged on the periphery of the corresponding reel are displayed on each display window. Additionally, the display windows 4L, 4C, 4R constitute a part of symbol display means for displaying some symbols of the plural symbols arranged on the periphery of the respective reels.

In addition, winning lines are formed on the display windows 4L, 4C, 4R, which connect predetermined areas of the upper, center and lower parts of each display window 4L, 4C, 4R. The winning lines comprises a top line 8b, a center line 8c, a bottom line 8d, a cross-up line 8a and a cross-down line 83.

The center line 8c is a line connecting the center parts of the respective display windows 4L, 4C, 4R. The top line 8b is a line connecting the upper parts of the respective display windows 4L, 4C, 4R. The bottom line 8d is a line connecting the lower parts of the respective display windows 4L, 4C, 4R. The cross-up line 8a is a line connecting the lower part of the left display window 4L, the center part of the center display window 4C and the upper part of the right display window 4R. The cross-down line 8e is a line connecting the upper part of the left display window 4L, the center part of the center display window 4C and the lower part of the right display window 4R.

These winning lines 8a to 8e are activated by operating one of a 1-BET button 11, 2-BET button 12 and a MAX-BET button 13 or inserting a medal into a medal insertion slot 22, which will be described later (an activated winning line is referred to as an activated line).

A horizontal base portion 10 is provided below the display windows 4L, 4C, 4R and a liquid crystal display device 5 is mounted between the base portion 10 and the display windows 4L, 4C, 4R. Information about a game and the like is displayed on a display screen 5a of the liquid crystal display device 10.

The medal insertion slot 22 for inserting a medal into the gaming machine 1 is provided to a right side of the liquid crystal display device 5. When the medal is inserted into the medal insertion slot 22, the winning lines 8a to 8e are activated (an activated winning line is referred to as an activated line). In addition, if four or more medals are continuously inserted from the medal insertion slot 22, the medals are stacked in the gaming machine 1 (so-called credit). In addition, the gaming machine 1 uses a medal as a game medium. However, the game medium used in the gaming machine 1 is not limited to the medal, and a gaming ball, a token, a card storing information about an amount of the medals, and the like may be applied.

The 1-BET button 11, the 2-BET button 12 and the MAX-BET button 13 for determining the number of medals inserted for a unit game (for example, a one game from after the reels start to rotate, until the rotations are stopped and thus a game result is obtained) are mounted to a left side of the liquid crystal display device 5. When the 1-BET button 11 is operated, one piece is inserted from the medals credited, when the 2-BET button 12 is operated, two pieces are inserted, and when the MAX-BET button 13 is operated, three pieces are inserted.

To the left side of the display windows 4L, 4C, 4R are mounted a 1-BET lamp 9a, a 2-BET lamp 9b and a MAX-BET lamp 9c. The 1-BET lamp 9a, 2-BET lamp 9b and MAX-BET lamp 9c are turned on in correspondence with the number of medals inserted for a unit game (hereinafter, refereed to as “insertion number”). When the insertion number is one, two and three pieces, the 1-BET lamp 9a, the 2-BET lamp 9b and the MAX-BET lamp 9c are turned on, respectively.

An information display unit 18 is mounted at a lower part of the BET lamps 9a, 9b, 9c. The information display unit 18 consists of 7 segment LEDs and displays the number of medals stored in the gaming machine 1 (so-called “credit”), the number of medals to be paid out for a player (hereinafter, referred to as “payout number”) and the like.

An operating unit 17 is mounted above the BET buttons 11, 12, 13, which consists of a cross key, a selection button and a determination button. Based on an operation of the operating unit 17 by the player, the information about a game such as game history is displayed on the display screen 5a of the liquid crystal display device 5.

A C/P button 14 for changing credits or payouts of medals is mounted to a frontal left side of the base portion 10. In case that the payout is carried out, the medals as the payout number are paid out from a frontal lower medal payout slot 15 and stacked on a medal tray 16. In addition, in case that the credit is carried out, the medals as the payout number are credited. Herein, the payout and credit of the medal may be simply referred to as “payout”.

To a right side of the C/P button 14 is mounted a start lever 6 for rotating the reels 3L, 3C, 3R by a start operation and starting to vary the symbols displayed in the display windows 4L, 4C, 4R.

Stop buttons 7L, 7C, 7R which are mounted to correspond to the reels 3L, 3C, 3R and stop the rotations of the respective reels 3L, 3C, 3R are mounted below the liquid crystal display device 5 in a frontal center of the base portion 10.

Hereinafter, a stop operation which is first carried out when all the reels 3L, 3C, 3R are rotated (i.e., a player's push operation for the stop buttons 7L, 7C, 7R) will be referred to as “first stop operation”, a stop operation which is carried out following the first stop operation when the two reels are rotated will be referred to as “second stop operation”, and a stop operation which is carried out following the second stop operation when the remaining one reel is rotated will be referred to as “third stop operation”.

In addition, a LED 101 and a lamp 102 are mounted at an upper part of the front door 1b. The LED 101 and the lamp 102 emit lights with a radiation pattern in correspondence with game situations and perform a game effect.

Speakers 21L, 21R are mounted at upper left and right sides of the medal tray 16. Sound such as effect sound or sing in correspondence with game situations is outputted from the speakers 21L, 21R to make the game effect.

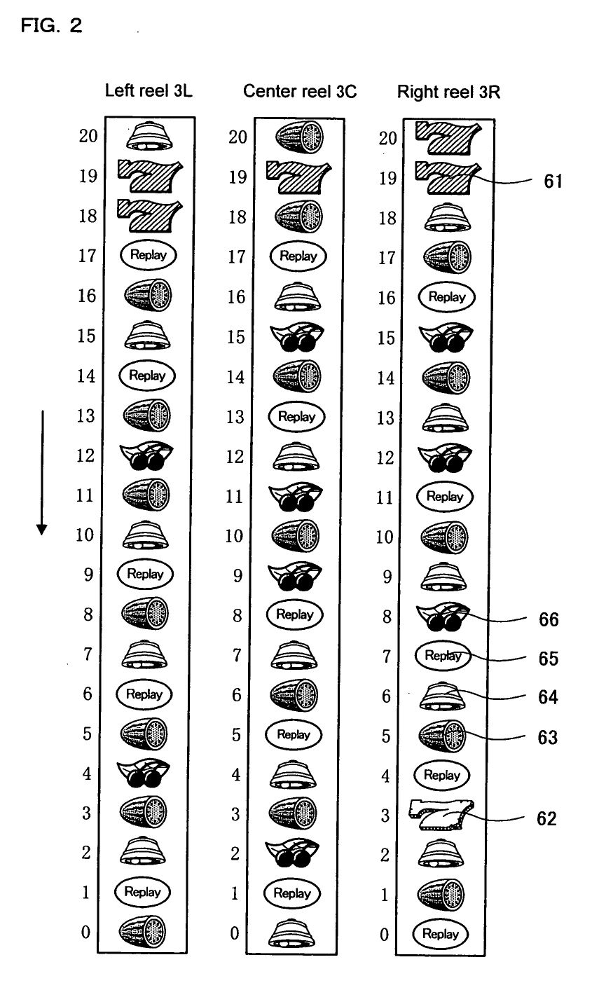

With reference to FIG. 2, a structure of symbols arranged on the reels 3L, 3C, 3R is described.

The plural types of 21 symbols are arranged on each periphery of the reels 3L, 3C, 3R. Specifically, the plural areas (i.e., 21 areas), each of which is allotted to a one symbol, are provided to the periphery of the respective reels 3L, 3C, 3R. Each of the corresponding areas is arranged with each symbol such as Red 7 (symbol 61), Blue 7 (symbol 62), Watermelon (symbol 63), Bell (symbol 64), Replay (symbol 65) and Cherry (symbol 66). In addition, each of the reels 3L, 3C, 3R is rotated in an arrow direction as shown in FIG. 2.

In the followings, it is described a circuit structure of the gaming machine 1 comprising a main control circuit 71, a sub-control circuit 72 and a peripheral device (actuator) electrically connected to the main control circuit 71 or sub-control circuit 72, with reference to FIG. 3.

The main control circuit 71 comprises a micro computer 30 arranged on a circuit board as a main constituting element and is further provided with a circuit for sampling random numbers. The micro computer 30 includes a CPU 31 and a ROM 32 and a RAM 33 which are storing means.

To the CPU 31 is connected a clock pulse generating circuit 34, a frequency divider 35, a random number generator 36 and a sampling circuit 37. The clock pulse generating circuit 34 and the frequency divider 35 generate a reference clock pulse. Based on the generated reference clock pulse, an intervention process which will be described later is carried out. The random number generator 36 generates a random number within a predetermined range (for example, 0˜65535). The sampling circuit 37 extracts (samples) one random number from the random numbers generated by the random number generator 36. By using the sampled random number, an internal lottery process and the like is carried out, which will be described later, and predetermined information (for example, winning number) is determined.

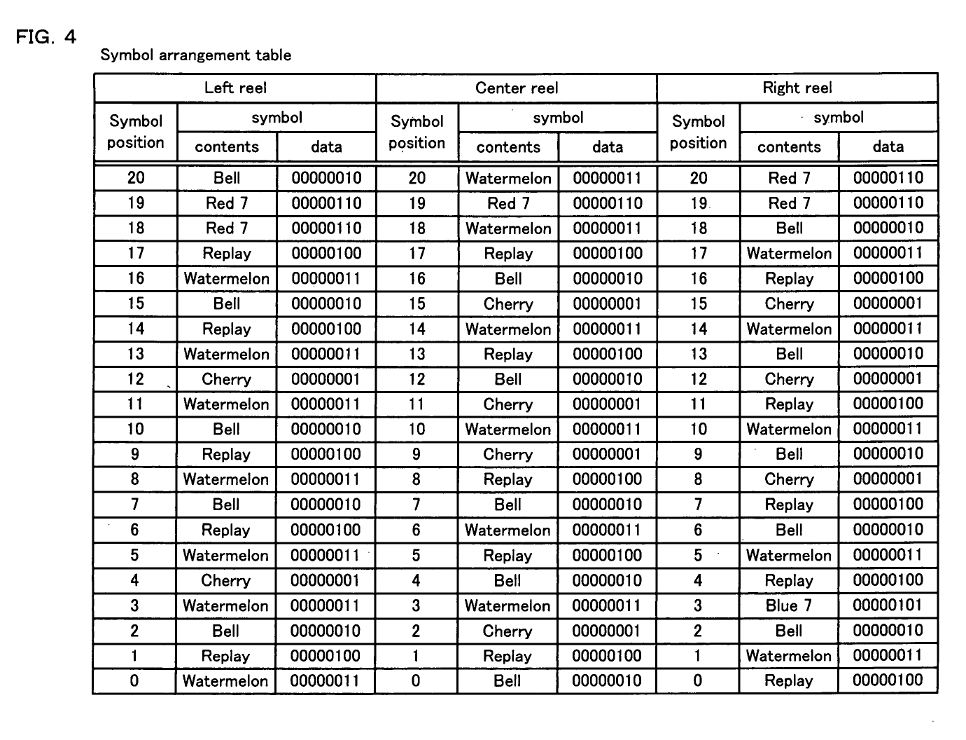

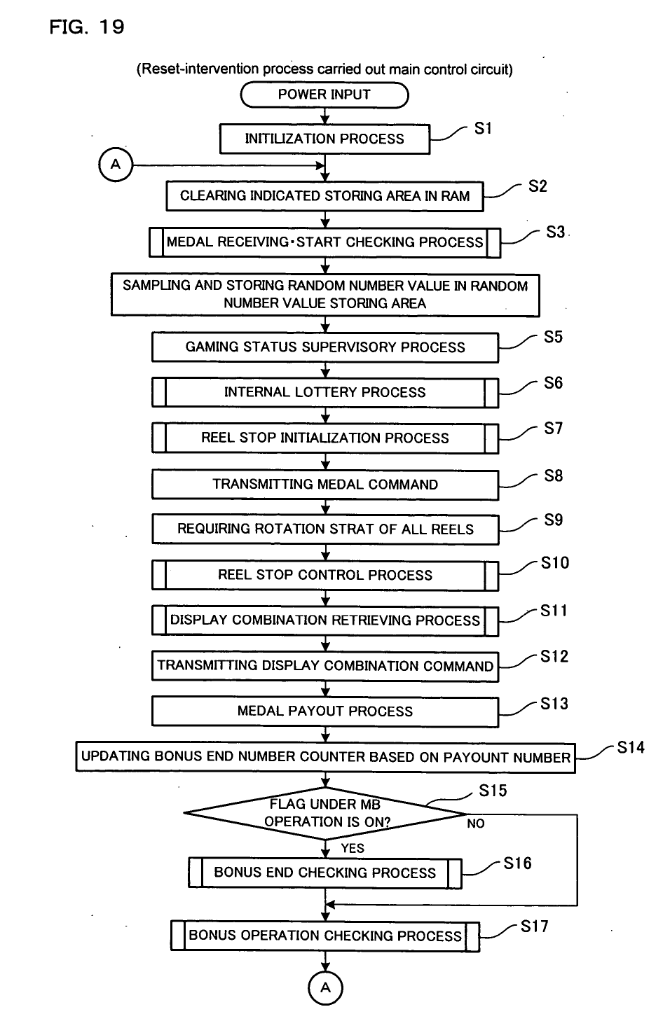

The ROM 32 of the micro computer 30 is memorized with a program relating to the process of the CPU 31 (for example, see FIGS. 19 to 30), various tables such as priority attraction-in ranking table (for example, see FIGS. 4 to 13), various control commands for being transmitted to the sub-control circuit 72 and the like. In addition, the ROM 32 constitutes a part of stop table memory means. Additionally, the ROM 32 constitutes a part of retrieval order table memory means.

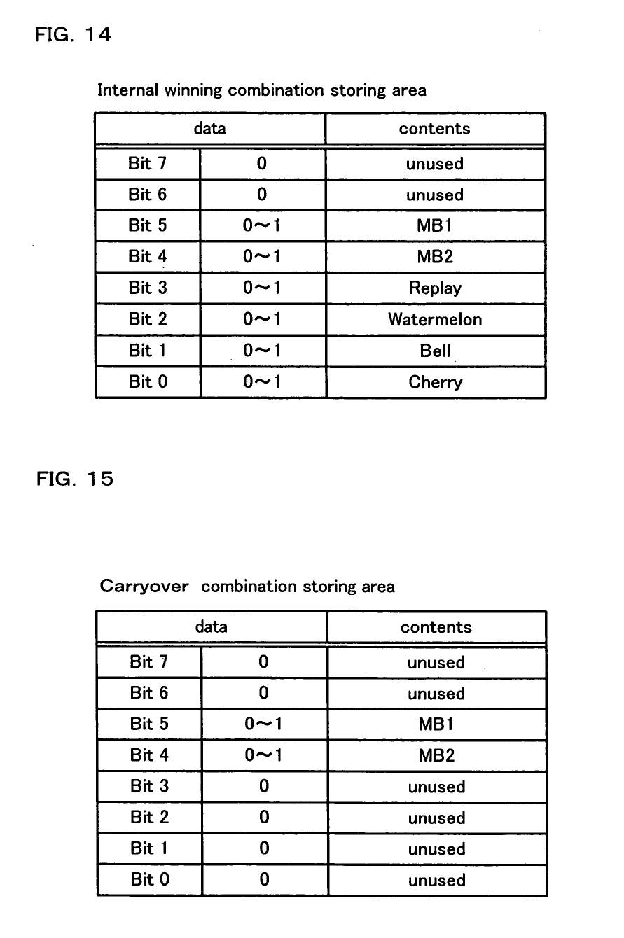

Various data obtained according to the process of the CPU 31 is memorized in the RAM 33. For example, it is provided with an expected display combination storing area for storing a priority attraction-in status in accordance with a position of each symbol which will be described later (for example, see FIGS. 14 to 17). In addition, the data is transmitted to the sub-control circuit 72 by the commands.

In the circuit shown in FIG. 3, main actuators controlled by a control signal from the micro computer 30 include the BET lamps 9a, 9b, 9c, an information display unit 18, a hopper 40, stepping motors 49L, 49C, 49R and the like.

In addition, to an output unit of the micro computer 30 is connected each circuit for receiving the control signals outputted from the CPU 31 to control the operations of the respective actuators. The circuits include a motor driving circuit 39, a lamp driving circuit 45, a display unit driving circuit 48 and a hopper driving circuit 41.

The lamp driving circuit 45 controls the driving of the BET lamps 9a, 9b, 9c. Thereby, the BET lamps 9a, 9b, 9c are turned on or off.

The display unit driving circuit 48 controls the driving of the information display unit 18. Thereby, various information (credit number, etc.) is displayed on the information display unit 18.

The hopper driving circuit 41 controls the driving of the hopper 40. Thereby, the medals received in the hopper 40 are paid out.

The motor driving circuit 39 outputs the pulse coming from the main control circuit 71 to the stepping motors 49L, 49C, 49R and controls the driving of the stepping motors 49L, 49C, 49R. Thereby, the reels 3L, 3C, 3R are rotated and stopped.

Herein, in this embodiment, it is counted the number of pulses outputted to the stepping motors 49L, 49C, 49R from after a reel index indicating one revolution of the reel is detected by a reel position detection circuit 50, thereby detecting a rotation angel of the reel on the basis of the detected position of the reel index. In addition, there is provided a gear (not shown) transferring the rotations of the stepping motors 49L, 49C, 49R to the reels 3L, 3C, 3R with a predetermined reduction ratio. Additionally, the pulse is outputted 16 times to the stepping motors 49L, 49C, 49R, so that the reel is rotated as a one symbol arranged on the periphery of the reel.

More specifically, the number of pulses outputted to the stepping motors 49L, 49C, 49R is counted by a pulse counter of the RAM 33 and a symbol counter of the RAM 33 is added by one whenever 16 times of pulse outputs are counted by the pulse counter. In addition, a value of the symbol counter is cleared whenever the reel index is detected.

Herein, each of the symbols arranged on the periphery of the reel is defined with symbol positions “0”˜“20” for discriminating each of the symbols in regular order from the rotation direction of the reel. The reel index is detected by the reel position detection circuit 50 so that the symbol corresponding to the symbol position “0” is located on the center line 8c (more specifically, a center part of the longitudinal direction of the respective display windows 4L, 4C, 4R).

In other words, when the value of the symbol counter becomes “0” by the detection of the reel index, the symbol corresponding to the symbol position “0” is located on the center line 8c, so that the symbol counter and the symbol position correspond to each other. Accordingly, by referring to the symbol counter, it is possible to specify the symbol located on the center line 8c. In addition, the symbol counter constitutes a part of symbol specifying means for specifying a symbol located at a predetermined position (for example, center line 8c).

In addition, to an input unit of the micro computer 30 is connected a switch and the like which outputs predetermined signals performing the controls of the actuators. Specifically, a start switch 6S, a stop switch 7S, a 1-BET switch 11S, a 2-BET switch 12S, a MAX-BET switch 13S, a C/P switch 14S, a medal sensor 22S, the reel position detection circuit 50 and a payout completion signal circuit 51 are connected.

The start switch 6S detects an inclination moving operation by the player (i.e., start operation) and outputs a detected signal to the micro computer 30. In addition, the start switch 6S constitutes a part of start operation detection means.

The stop switch 7S detects a push operation by the player for the stop buttons 7L, 7C, 7R (i.e., stop operation), respectively, and outputs a detected signal to the micro computer 30. In addition, the stop switch 7S constitutes a part of stop operation detection means.

The 1-BET switch 11S, the 2-BET switch 12S and the MAX-BET switch 13S detect push operations (i.e., insertion operations) of the player for the 1-BET button 11, the 2-BET button 12 and the MAX-BET button 13 and output a detected signal to the micro computer 30.

The medal sensor 22S detects a medal inserted into the medal insertion slot 22 by an operation of the player (i.e., insertion operation) and outputs a detected signal to the micro computer 30.

The C/P switch 14S detects a push operation by the player for the C/P button 14 and outputs a detected signal to the micro computer 30.

The reel position detection circuit 50 detects the reel index indicating one revolution of the reel for each of the reels 3L, 3C, 3R and outputs a detected signal to the micro computer 30.

The payout completion signal circuit 51 detects whether the number of medals (i.e., the number of medals paid out from the hopper 40) reaches an indicated payout number through a medal detection unit 40S and outputs a detected signal to the micro computer 30.

The sub-control circuit 72 executes processes (determination or execution of contents of effect) based on the various commands (for example, start command, etc.) outputted from the main control circuit 71. In addition, the sub-control circuit 72 does not input the command, information and the like into the main control circuit 71. In other words, it is carried out a one-way communication from the main control circuit 71 to the sub-control circuit 72.

The main actuators controlled by the sub-control circuit 72 include the liquid crystal display device 5, the speakers 21L, 21R, the LED 101 and the lamp 102. Based on the contents of effect determined, the sub-control circuit 72 carries out the determination and display of an image to be displayed on the liquid crystal display device 5, the determination and output of lighting patterns of the LED 101 or lamp 102 and the determination and output of the effect sound outputted from the speakers 21L, 21R, and the like.

In addition, the sub-control circuit 72 is connected with the operating unit 17 and a sound volume adjusting unit 103 and outputs an image or sound on the basis of the signals outputted from them.

In the followings, a symbol arrangement table is described with reference to FIG. 4.

The symbol arrangement table shows the structure of symbols arranged on the peripheries of the reels 3L, 3C, 3R, as data. In other words, the symbol arrangement table defines Red 7, Blue 7, Watermelon, Replay and Cherry in the same arrangement as FIG. 2. A type of each symbol is represented by 1 byte data, as shown. For example, the data representing the Red 7 is “00000110”.

In addition, with the symbol located on the center line 8c being defined as the symbol position “0” when the reel index is detected, the symbol arrangement table defines the symbol positions “0” to “20” corresponding to the symbol counter and the types of symbols corresponding to the respective symbol positions. Accordingly, based on the symbol arrangement table and the symbol counter, types of symbols on the center line 8c of the respective reels 3L, 3C, 3R can be specified. For example, when the symbol counter of the right reel 3R is “3”, it is specified that the Blue 7 (symbol 62) of the symbol position “3” of the right reel 3R is located on the center line 8c. In addition, by referring to the symbol counter and the symbol arrangement table, besides the symbol located on the center line 8c, it is possible to specify symbols adjacent to the corresponding symbol and types thereof. Further, the symbol arrangement table constitutes a part of the symbol specifying means.

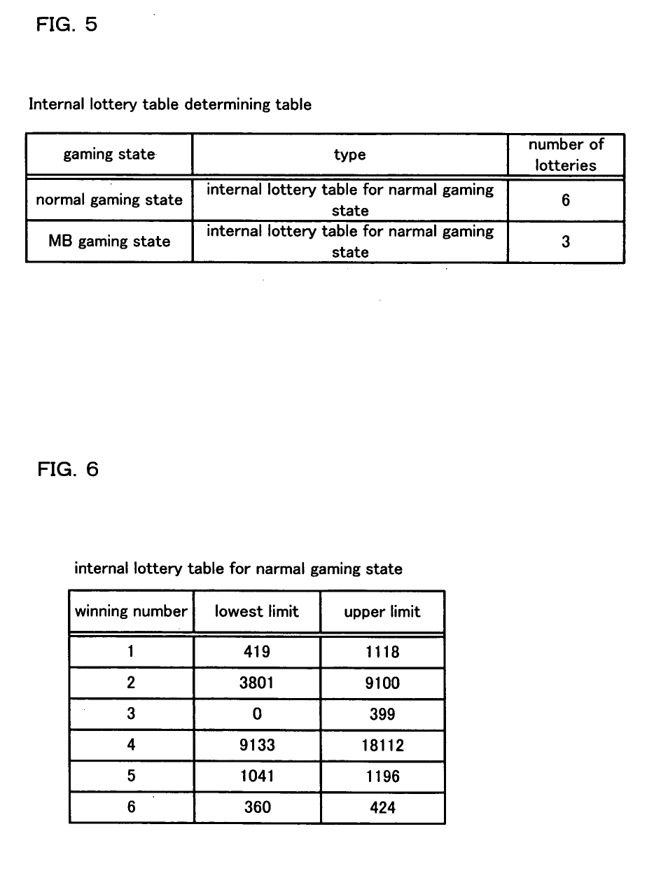

In the followings, an internal lottery table determining table is described with reference to FIG. 5.

The internal lottery table determining table defines a type of an internal lottery table determined in accordance with the gaming state and the number of lotteries. In a normal gaming state, it is determined an internal lottery table for a normal gaming state and the number of lotteries is determined to be 6. In a middle bonus (hereinafter, abbreviated to “MB”) gaming state, it is determined an internal lottery table for a normal gaming state and the number of lotteries is determined to be 3.

Hereinafter, an internal lottery table is described with reference to FIG. 6.

The internal lottery table defines the lowest and upper limits of random numbers allotted in accordance with each of winning numbers. The winning number is data used to determine the internal winning combination and the like.

In the internal lottery table, it is carried out a retrieval about whether the random number value sampled from the range of “0˜65535” is included between the lowest limit and the upper limit of the random numbers allotted to the respective winning numbers, in descending power of the winning numbers. In case that the sampled random number value is included between the lowest limit and the upper limit, a corresponding winning number is determined. The number of lotteries indicates the number of the above retrievals. In addition, as a result of performing the retrieval as the number of lotteries, in case that it dose not correspond to any winning number, the winning number 0 is determined.

In the internal lottery table for a normal gaming state, the lowest and upper limits of the random number value allotted to each of the winning numbers 1˜6 are defined. Herein, a winning probability of each winning number can be calculated by “(1+ difference between the lowest and upper limits defined for each winning number)/the number of all random number values occurring (i.e., 65536)”. In addition, the internal lottery table for the normal gaming state according to this embodiment does not have such a structure that the winning probabilities of each winning number are different in accordance with the insertion number. However, it may have such structure that the winning probabilities of each winning number are different in accordance with the insertion number.

In addition, the internal lottery table for the normal gaming state may be defined with values duplicating for the plural winning numbers. When the random number value included in the duplicating values is sampled, the plural winning numbers are determined together. For example, in case that the sampled random number value is within a range of “419˜424”, the winning number 1 (i.e., Cherry) and the winning number 6 (i.e., MB1) are determined together.

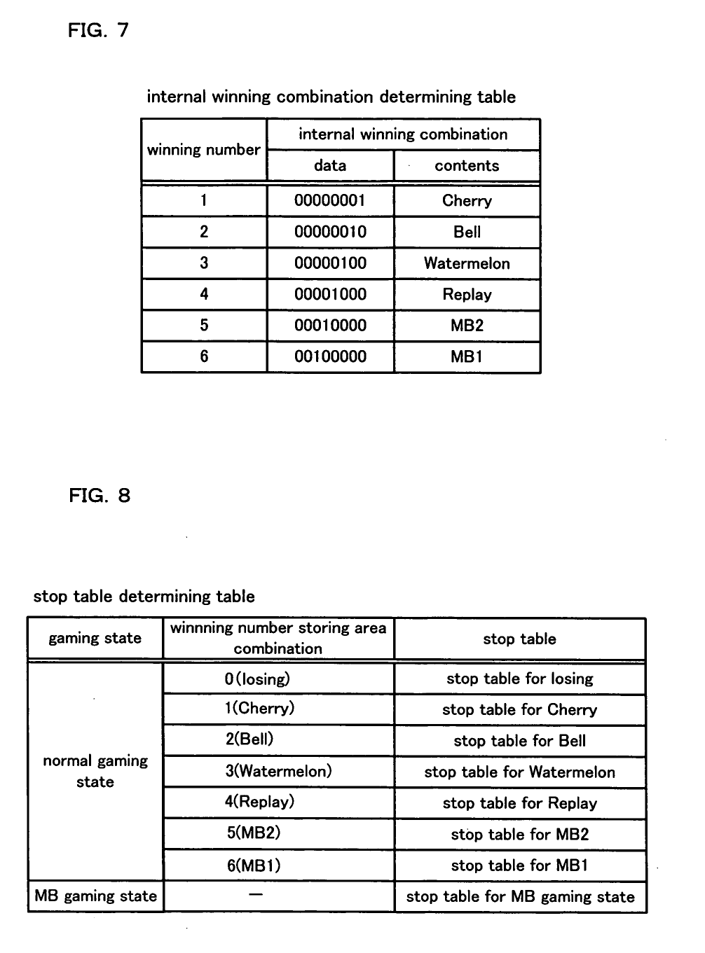

In the followings, an internal winning combination determining table is described with reference to FIG. 7.

The internal winning combination determining table defines an internal winning combination in correspondence with the winning number. Specifically, each of Cherry, Bell, Watermelon, Replay, MB2 and MB1 is defined in correspondence with each of the winning numbers 1˜6. In other words, if a winning number is determined in accordance with the internal lottery table for the normal gaming state, since an internal winning combination is determined in correspondence with the corresponding winning number, it can be said that the determination of the winning number is equivalent to the determination of the internal winning combination.

In addition, the type of each internal winning combination is indicated by 1 byte data, as shown, and a bit string in correspondence with the type of each internal winning combination becomes ON. For example, the data indicating the MB1 is “00100000”.

In the followings, a stop table determining table is described with reference to FIG. 8.

The stop table determining table defines a type of a stop table determined every gaming state. In the normal gaming state, it is defined a type of a stop table in correspondence with the winning number stored in the winning number storing area. Specifically, in correspondence with each of winning numbers 1˜6, it is defined stop tables corresponding to each of losing, Cherry, Bell, Watermelon, Replay, MB2 and MB1. In addition, in the MB gaming state, it is defined only a stop table for the MB gaming state and the corresponding stop table is determined irrespective of the winning number.

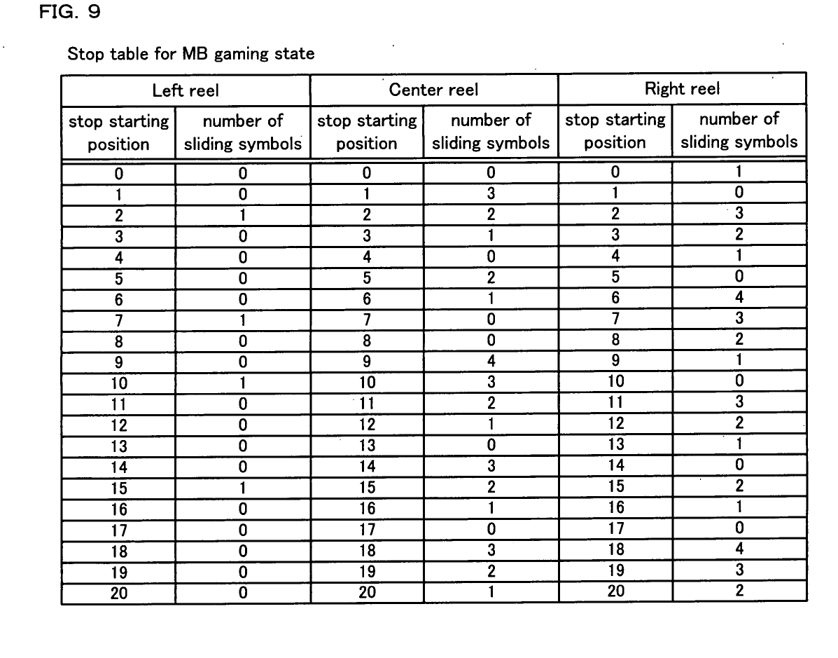

In the followings, a stop table is described with reference to FIG. 9.

The stop table defines the number of sliding symbols in correspondence with the symbol position (i.e., a symbol position from which the rotation of reel starts to be stopped, and referred to as “stop starting position”) corresponding to the symbol counter of the corresponding reel when the stop operation is detected by the stop switch 7S.

The number of sliding symbols is a rotation amount of reel from after the stop operation is detected by the stop switch 7S until the rotation of reel is stopped. In other words, it is the number of symbols passing through the center line 8c, from after the stop operation is detected by the stop switch 7S until the rotation of the corresponding reel is stopped. It is perceived by a value of the symbol counter updated from after the stop operation is detected by the stop switch 7S.

In the gaming machine 1, after a signal is outputted by the stop switch 7S, a control for stopping the rotations of the reels 3L, 3C, 3R is carried out within 190 msec. The number of sliding symbols is defined as the maximum “4”. For example, if the stop starting position is “0” and the number of sliding symbols determined is “4”, it is possible to stop the rotation of reel so that a symbol of the symbol position “4” is displayed on the center line 8c.

Like this, the control for stopping the rotation of reel is referred to as “attraction-in”, which allows the symbols within a range of the number of sliding symbols from the stop starting position to be displayed on the center line 8c. In addition, the position of the symbol which is attracted-in as the number of sliding symbols from the stop starting position and then stopped is referred to as “expected stop position”.

FIG. 9 shows a stop table for a MB gaming state. Herein, in the MB gaming state, a signal is outputted by the stop switch 7S to at least one of the reels 3L, 3C, 3R (in this embodiment, only the left reel 3L is applied) and then the rotation is stopped within 75 msec, and the number of sliding symbols is defined as the maximum “1”. In addition, for the other reels (in this embodiment, center and right reels 3C, 3R) except the reel in which the number of sliding symbols is defined as the maximum “1”, the number of sliding symbols is defined as the maximum “4”, likewise the normal gaming state.

As a result of that, in the MB gaming state, since the number of symbols which can be attracted-in for the left reel 3L is reduced as compared to the normal gaming state, it is required for the player to have a higher skill regarding the stop operation. However, in the MB gaming state, it is structured such that the combination of symbols relating to Cherry, Bell or Watermelon can be displayed on the center line 8c depending on the timing of the stop operation, which will be more specifically described later. Accordingly, in the MB gaming state, although it is required for the player to have a higher skill as compared to the other gaming state, a desired winning can be achieved depending on the skill and thus it becomes a gaming state advantageous to the player.

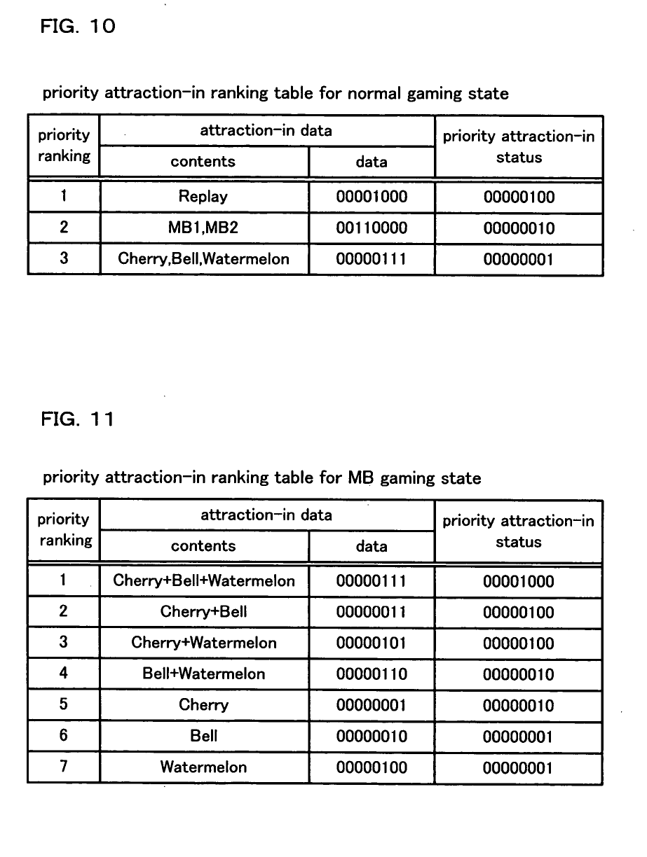

In the followings, a priority attraction-in ranking table is described with reference to FIGS. 10 and 11.

The priority attraction-in ranking table defines attraction-in data and a priority attraction-in status in correspondence with each of priority rankings. The priority ranking defines a ranking in which the attraction-in is preferentially carried out between the types of the internal winning combination (or types of symbol).

The attraction-in data is expressed by one byte data, likewise the data representing the internal winning combination and is defined in correspondence with each priority ranking. The attraction-in state is expressed by one byte data. The bit in correspondence with the priority ranking becomes ON, so that the attraction-in state is expressed. The priority attraction-in status has such a structure that the higher the priority ranking, the upper bit is ON, and the higher the priority ranking, the greater a value of the priority attraction-in status .

FIG. 10 shows a priority attraction-in ranking table for the normal gaming state. In the priority attraction-in ranking table for the normal gaming state, each of the priority rankings 1˜3 is defined with the attraction-in data and the priority attraction-in status .

Specifically, the priority ranking 1 is defined with the attraction-in data “00001000” representing the “Replay” and the priority attraction-in status “00000100”. In addition, the priority ranking 2 is defined with the attraction-in data “00110000” representing the “MB1, MB2” and the priority attraction-in status “00000010”. In addition, the priority ranking 3 is defined with the attraction-in data “00000111” representing the “Cherry, Bell, Watermelon” and the priority attraction-in status “00000001”.

Herein, in the priority attraction-in ranking table for the normal gaming state, MB1 and MB2 or Cherry, Bell and Watermelon are grouped to define a one priority ranking. Thereby, it is possible to reduce the values capable of being adopted as the priority ranking and to reduce the data capacity, as compared to the case that the priority ranking is respectively defined in each of the internal winning combinations.

FIG. 11 shows a priority attraction-in ranking table for the MB gaming state. In the priority attraction-in ranking table for the MB gaming state, each of the priority rankings 1˜7 is defined with the attraction-in data and the priority attraction-in status.

Specifically, the priority ranking 1 is defined with the attraction-in data “00000111” representing the “Cherry+Bell+Watermelon” and the priority attraction-in status “00001000”. Herein, the above “Cherry, Bell, Watermelon” is meant by that any one of Cherry, Bell and Watermelon can be attracted-in, whereas the “Cherry+Bell+Watermelon” is meant by that all of Cherry, Bell and Watermelon can be attracted-in.

In addition, the priority ranking 2 is defined with the attraction-in data “00000011” representing the “Cherry+Bell” and the priority attraction-in status “00000100”. In addition, the priority ranking 3 is defined with the attraction-in data “00000101” representing the “Cherry+Watermelon” and the priority attraction-in status “00000100”. The priority attraction-in status defined in the priority ranking 2 is same as the priority attraction-in status defined in the priority ranking 3.

In addition, the priority ranking 4 is defined with the attraction-in data “00000110” representing the “Bell +Watermelon” and the priority attraction-in status “00000010”. In addition, the priority ranking 5 is defined with the attraction-in data “00000001” representing the “Cherry” and the priority attraction-in status “00000010”. The priority attraction-in status defined in the priority ranking 4 is same as the priority attraction-in status defined in the priority ranking 5.

In addition, the priority ranking 6 is defined with the attraction-in data “00000010” representing the “Bell” and the priority attraction-in status “00000001”. In addition, the priority ranking 7 is defined with the attraction-in data “00000100” representing the “Watermelon” and the priority attraction-in status “00000001”. The priority attraction-in status defined in the priority ranking 6 is same as the priority attraction-in status defined in the priority ranking 7.

In the priority attraction-in table for the MB gaming state, the priority rankings are defined in a magnitude order of awards paid out to the player (i.e., payout number of medals). In other words, when the rotation of one reel is stopped, the attraction-in data and the priority attraction-in status are made to correspond to each other so that the combination of symbols displayed on the upper, center and lower parts of the corresponding display window is more advantageous to the player. In addition, in case that the awards paid out to the player are approximately same, the same value of priority attraction-in status is defined. Accordingly, it is structured in consideration of the profits of the player.

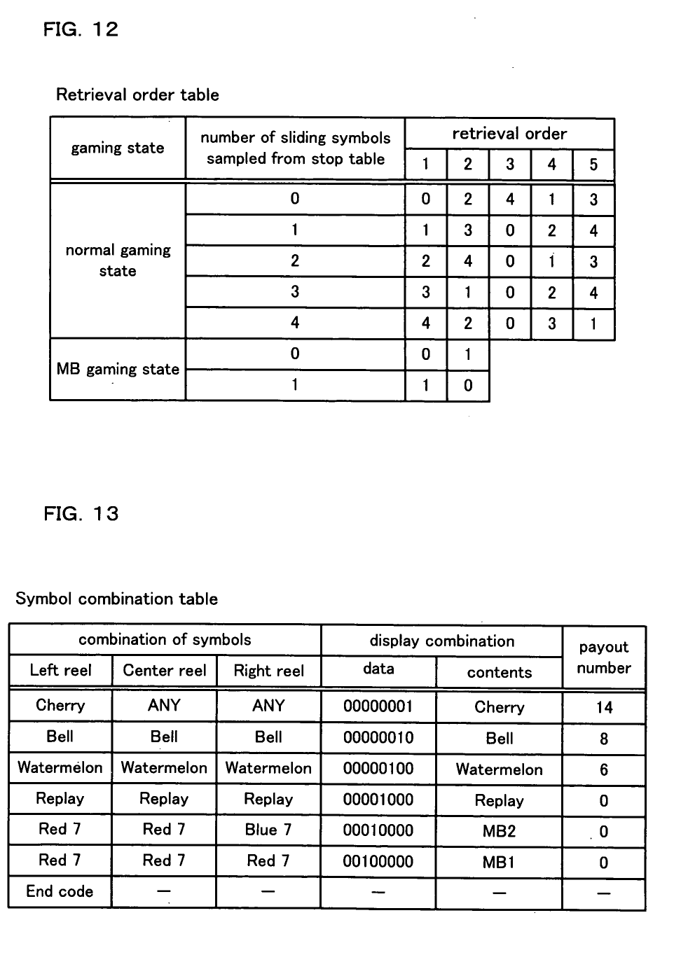

In the followings, a retrieval order table is described with reference to FIG. 12.

The retrieval order table defines an order of retrieving (hereinafter, referred to as retrieval order) whether a numerical value of the predetermined range (i.e., 0 or 1 only for the left reel 3L in the MB gaming state, and 0˜4 except it) is proper as the number of sliding symbols or not. In the retrieval order table, the retrieval order is defined on the basis of the number of sliding symbols sampled from the stop table for every gaming state.

In the normal gaming state, one of the numbers of sliding symbols “0” to “4” is defined in order of the retrieval orders 1 to 5. If the number of sliding symbols sampled from the stop table is “0”, the number of sliding symbols is obtained in accordance with an order of “0→2→4→1→3” and the retrieval is carried out. In addition, if the number of sliding symbols sampled from the stop table is “1”, the number of sliding symbols is obtained in accordance with an order of “1→3→0→2→4” and the retrieval is carried out. In addition, if the number of sliding symbols sampled from the stop table is “2”, the number of sliding symbols is obtained in accordance with an order of “2→4→0→1→3” and the retrieval is carried out. Additionally, if the number of sliding symbols sampled from the stop table is “3”, the number of sliding symbols is obtained in accordance with an order of “3→1→0→2→4” and the retrieval is carried out. In addition, if the number of sliding symbols sampled from the stop table is “4”, the number of sliding symbols is obtained in accordance with an order of “4→2→0→3→1” and the retrieval is carried out.

In the MB gaming state, for the left reel 3L only, one of the numbers of sliding symbols “0” and “1” is defined in order of the retrieval orders 1 and 2. If the number of sliding symbols sampled from the stop table is “0”, the number of sliding symbols is obtained in accordance with an order of “0→1” and the retrieval is carried out. In addition, if the number of sliding symbols sampled from the stop table is “1”, the number of sliding symbols is obtained in accordance with an order of “1→0” and the retrieval is carried out. In addition, for the center reel 3C and the right reel 3R in the MB gaming state, the number of sliding symbols is obtained in accordance with the retrieval order in the normal gaming state and the retrieval is carried out.

Like this, in the retrieval order table, it is structured such that the retrieval order of the number of sliding symbols sampled from the stop table becomes highest, among the retrieval orders defined on the basis of the number of sliding symbols sampled from the stop table. In other words, it is structured such that the retrieval about the number of sliding symbols sampled from the stop table is preferentially carried out over the other numbers of sliding symbols.

In the followings, a symbol combination table is described with reference to FIG. 13.

The symbol combination table defines a combination of symbols relating to the winning and a display combination and a payout number corresponding to it. The display combination is expressed by one byte data, likewise the data representing the internal winning combination. For example, the data representing the MB1 is “00100000”.

If the combination of symbols relating to Cherry, i.e., “Cherry-ANY (it indicates that a type of any symbol is allowed)—ANY” is displayed on the activated line, in other words, if Cherry (symbol 66) of the left reel 3L is displayed on any one of the upper, center and lower parts of the left display window 4L, a display combination is determined as Cherry, irrespective of the types of symbols displayed on the other display windows 4C, 4R. In addition, the payout number corresponding to Cherry is 14.

If the combination of symbols relating to Bell, i.e., “Bell-Bell-Bell” is displayed on the activated line, in other words, if Bell (symbol 64) of each of the reels 3L, 3C, 3R is respectively displayed in a low along the activated line, a display combination is determined as Bell. In addition, the payout number corresponding to Bell is 8.

If the combination of symbols relating to Watermelon, i.e., “Watermelon-Watermelon-Watermelon” is displayed on the activated line, in other words, if Watermelon (symbol 63) of each of the reels 3L, 3C, 3R is respectively displayed in a low along the activated line, a display combination is determined as Watermelon. In addition, the payout number corresponding to Watermelon is 6.

If the combination of symbols relating to Replay, i.e., “Replay-Replay-Replay” is displayed on the activated line, in other words, if the Replay (symbol 65) of each of the reels 3L, 3C, 3R is respectively displayed in a low along the activated line, a display combination is determined as Replay. In addition, in case that the Replay is determined, a re-game is carried out in a next unit game. In other words, the same number of medals as the insertion number in the unit game in which Replay has been achieved is automatically inserted in the next unit game without the insertion operation by the player. Thereby, the player can play the next unit game without consuming the medal.

If the combination of symbols relating to MB2, i.e., “Red 7-Red 7-Blue 7” is displayed on the activated line, in other words, if the Red 7 (symbol 61) of the left reel 3L, the Red 7 of the center reel 3C and the Blue 7 (symbol 62) of the right reel 3R are displayed along the activated line, a display combination is determined as MB2. In addition, if the combination of symbols relating to MB1 “Red 7-Red 7-Red 7” is displayed on the activated line, in other words, if the Red 7 of each of the reels 3L, 3C, 3R is respectively displayed in a low along the activated line, a display combination is determined as MB1. In case that the MB1 or MB2 (which can be generally referred to as “MB”) is determined, a flag under MB operation is updated to ON, which will be described later, and a MB operation starts.

In addition, in the symbol combination table, with Cherry being in the lead, an address is allotted in order of Bell, Watermelon, Replay, MB2, MB1 and end code. The retrieval of the display combination is over when it proceeds to the address of the end code.

In addition, as a result of the retrieval of the display combination, in case that the combination of symbols displayed on the activated line does not correspond to any one of the combinations of symbols relating to the winnings defined in the symbol combination table, the display combination is determined as losing. Herein, Cherry, Bell or Watermelon relates to the payout of the game medium (for example, medal). In addition, Replay relates to an operation of a re-game. Additionally, MB1 or MB2 relates to an operation of a gaming state advantageous to the player (for example, MB gaming state).

In the followings, it is described a structure of an internal winning combination storing area of the RAM 33 of the main control circuit 71, with reference to FIG. 14.

If an internal winning combination is determined by the internal winning combination determining table, it is stored (memorized) in an internal winning combination storing area. The internal winning combination storing area consists of one byte and corresponds to the structure of the data of the internal winning combination described above. In other words, the bit string corresponding to the type of the determined internal winning combination becomes ON. In addition, in case of the losing, all bits become 0. Additionally, in case that two or more types of internal winning combinations are determined, all the bit strings corresponding to each type become ON. For example, in case that Cherry and MB1 are determined, the internal winning combination storing area becomes “00100001”. In addition, a display combination storing area and a pseudo display combination storing area have the same structure as the internal winning combination storing area, which will be described later.

In the followings, it is described a structure of the internal carryover combination storing area of the RAM 33 of the main control circuit 71, with reference to FIG. 15.

If MB1 or MB2 is determined as the internal winning combination by the internal winning combination determining table, it is stored in the internal carryover winning combination storing area. The internal carryover winning combination consists of one byte. A bit 4 corresponds to MB2 and a bit 5 corresponds to MB1. In addition, when the MB operation starts, the data stored in the internal carryover combination storing area is cleared. In other words, in the gaming machine 1, if MB is determined, the data thereof is stored during a period until the MB operation starts (which is referred to as carryover). In addition, since the internal carryover combination is determined on the basis of the internal winning combination, it can be said that the internal carryover combination is a subordinate concept of the internal winning combination.

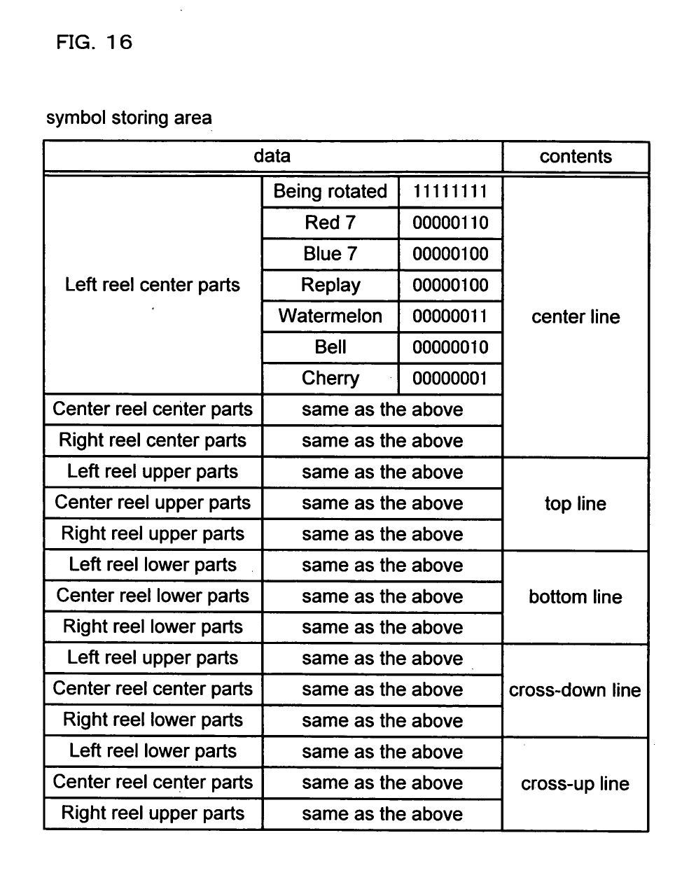

Next, it is described a structure of the symbol storing area of the RAM 33 of the main control circuit 71 with reference to FIG. 16.

The data representing types of the symbols displayed on each of the display windows 4L, 4C, 4R is stored in the symbol storing area. Each of the symbol storing areas consists of one byte and corresponds to the data representing the types of the symbols defined in the symbol arrangement table described above. In addition, the data representing that the reel is “being rotated” is expressed by “11111111”.

The type of symbol displayed on each of the display windows 4L, 4C, 4R is specified on the basis of the symbol position (or symbol counter) and the symbol arrangement table. The symbol storing area is provided to correspond to the center line 8c, the top line 8b, the bottom line 8d, the cross-down line 5e and the cross-up line 8a. For example, the symbol storing area corresponding to the center line 8c stores the type of symbol located at the center part of the left display window 4L, the type of symbol located at the center part of the center display window 4C and the type of symbol located at the center part of the right display window 4R, respectively. The display combination is determined on the basis of the data stored in all the symbol storing areas and the symbol combination table.

Herein, in case that an expectation of the display combination is carried out, the type of symbol to be displayed on the corresponding display window is specified and stored in the symbol storing area, based sequentially on the symbol positions “0”˜“20” of the retrieval target reel. In addition, in case that the rotation of each reel 3L, 3C, 3R is stopped, the type of the symbol displayed on the corresponding display window is specified and stored in the symbol storing area, based on the symbol counter of the stopped reel.

For example, if the retrieval target reel (or stopped reel) is the left reel 3L and the retrieval target symbol position (or symbol counter of stopped reel) is “0”, based on the symbol arrangement table, the type of symbol,of the symbol position “0”, the type of symbols of the symbol positions adjacent to the corresponding symbol position “0” (i.e., symbol position “1” over one and symbol position “20” under one) are specified. Accordingly, the Replay of the symbol position “1” with regard to the upper part of the left reel 3L, Watermelon of the symbol position “0” with regard to the center part thereof and Bell of the symbol position “20” with regard to the lower part thereof are respectively stored in the symbol storing area.

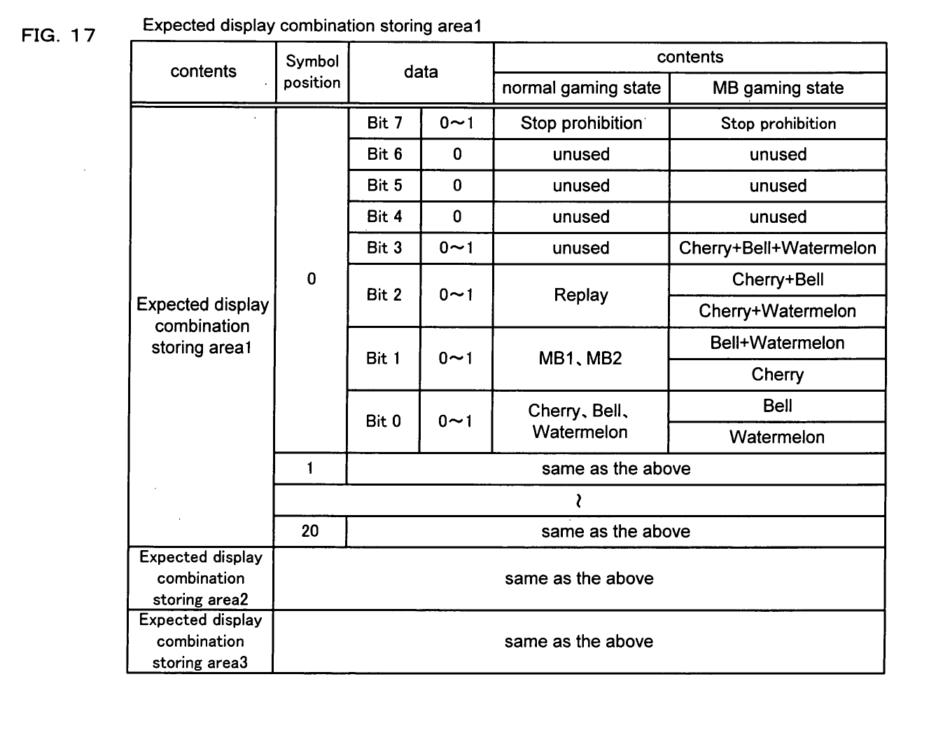

Hereinafter, a structure of an expected display combination storing area of the RAM 33 of the main control circuit 71 is described with reference to FIG. 17.

The expected display combination storing area is provided with 1˜3 expected display combination storing areas in correspondence with the number of the reels and stores the priority attraction-in status determined in correspondence with each of the symbol positions “0”˜“20” of the retrieval target reel. In addition, the priority attraction-in status is an example of the priority attraction-in ranking.

In the normal gaming state, the bit 0 of the priority attraction-in status corresponds to “Cherry, Bell, Watermelon”, the bit 1 corresponds to “MB1, MB2” and the bit 2 corresponds to “Replay”. In addition, in the MB gaming state, the bit 0 of the priority attraction-in status corresponds to “Bell” or “Watermelon”, the bit 1 corresponds to “Bell +Watermelon” or “Cherry”, the bit 2 corresponds to “Cherry+Bell” or “Cherry +Watermelon” and the bit 3 corresponds to “Cherry+Bell+Watermelon”. In addition, the bit 7 corresponds to “stop prohibition” in both the normal gaming state and the MB gaming state. In the symbol of the symbol position at which the “stop prohibition” is defined, the rotation of reel is not stopped.

In the priority attraction-in status, the greater the value (the upper bit is ON), the higher the priority ranking, except “10000000” representing the “stop prohibition”. Accordingly, by referring to the priority attraction-in status in accordance with each symbol position, it is possible to relatively evaluate the priority ranking between the symbols arranged on the periphery of the reel. In addition, the symbol of the symbol position determined to have the greatest value as the priority attraction-in status is the symbol having the highest priority ranking.

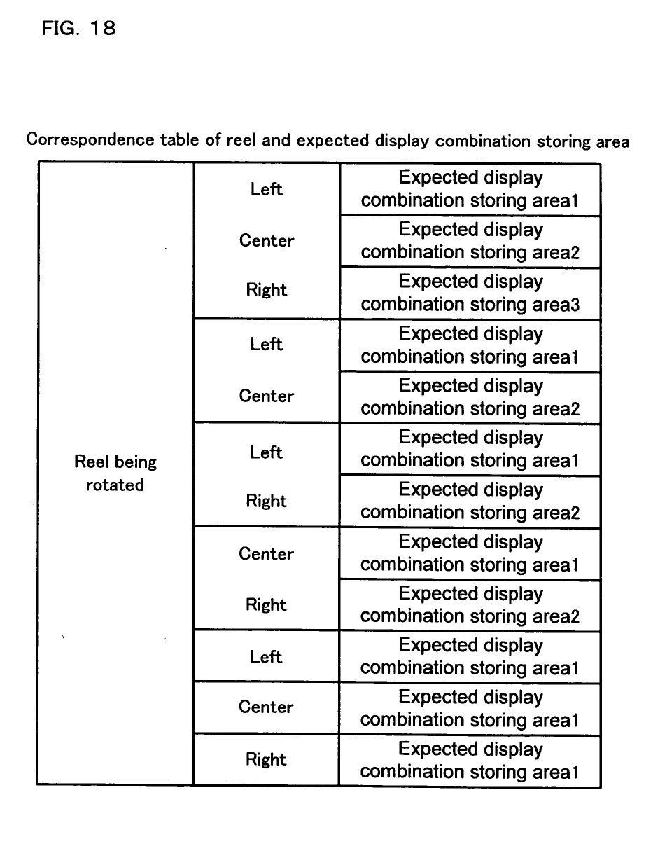

Next, a correspondence table of the reel and the expected display combination storing area is described with reference to FIG. 18.

In case that the reel being rotated is the left reel 3L, the center reel 3C and the right reel 3R (i.e., all of the reels), the left reel 3L corresponds to the expected display combination storing area 1, the center reel 3C corresponds to the expected display combination storing area 2 and the right reel 3R corresponds to the expected display combination storing area 3.

In addition, in case that the reel being rotated is the left reel 3L and the center reel 3C, the left reel 3L corresponds to the expected display combination storing area 1 and the center reel 3C corresponds to the expected display combination storing area 2. In addition, in case that the reel being rotated is the left reel 3L and the right reel 3R, the left reel 3L corresponds to the expected display combination storing area 1 and the right reel 3R corresponds to the expected display combination storing area 2. In addition, in case that the reel being rotated is the center reel 3C and the right reel 3R, the center reel 3C corresponds to the expected display combination storing area 1 and the right reel 3R corresponds to the expected display combination storing area 2.

In addition, in case that the reel being rotated is the left reel 3L, the left reel 3L corresponds to the expected display combination storing area 1. In addition, in case that the reel being rotated is the center reel 3C, the center reel 3C corresponds to the expected display combination storing area 1. In addition, in case that the reel being rotated is the right reel 3R, the right reel 3R corresponds to the expected display combination storing area 1.

Hereinafter, a control carried out by the CPU 31 of the main control circuit 71 is described with reference to FIGS. 19 to 30.

First, a reset-intervention process is described with reference to FIG. 19, which is executed by the CPU 31 of the main control circuit 71. When power is inputted and a voltage is applied to a reset terminal, the CPU 31 generates a reset-intervention and sequentially carries out a reset-intervention process which is stored in the ROM 32, on the basis of the generation of the reset-intervention.

When the power is inputted, the CPU first executes an initialization process (step S1). In the initialization process, it is carried out a process of restoring an execution address or data of a register stored in the RAM 33 when the power is cut off, for example.

Next, the CPU 31 clears an indicated storing area in the RAM 33 (step S2). Thereby, the data stored in the internal winning combination storing area, etc. of the RAM 33 is cleared.

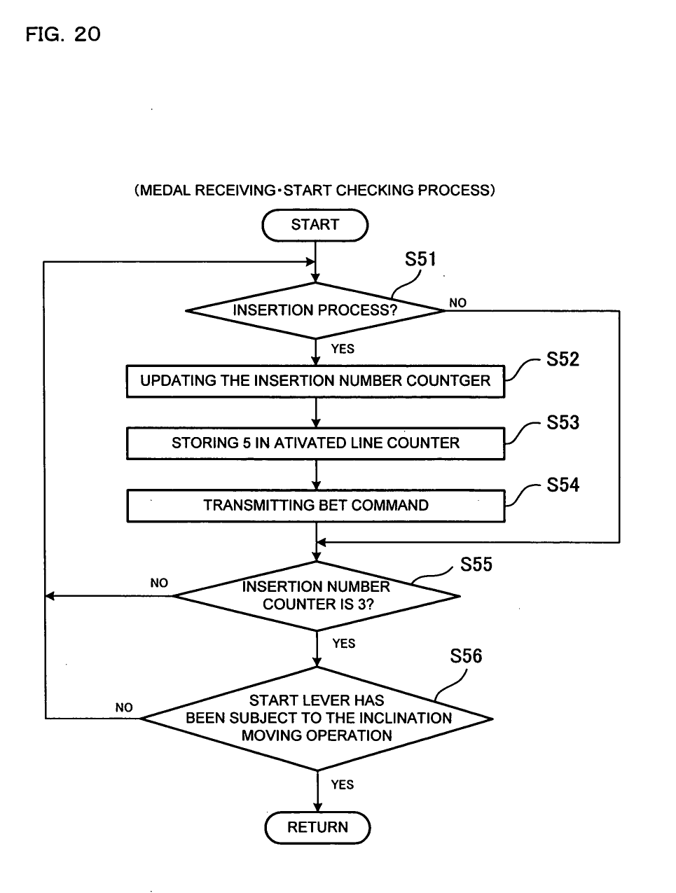

Next, the CPU 31 executes a medal receiving.start checking process which will be described later with reference to FIG. 20 (step S3). In the medal receiving.start checking process, it is carried out an update of the insertion number counter by the check of the medal sensor 22S, the BET switches 11S, 12S, 13S and the like, a check of an input of the start switch 6S, and the like.

Next, the CPU 31 samples and stores a random number value in the random number value storing area (step S4). Specifically, the CPU 31 samples a random number value for lottery by the random number generator 36 and the sampling circuit 37, which is used in the internal lottery process and the like, and stores it in the random number value storing area of the RAM 33.

Next, the CPU 31 executes a gaming status supervisory process (step S5). Specifically, the CPU 31 stores an identifier representing the MB gaming state (so-called flag) in the RAM 33 when a flag under MB operation is ON, and stores an identifier representing the normal gaming state in the RAM 33 when the flag under MB operation is OFF.

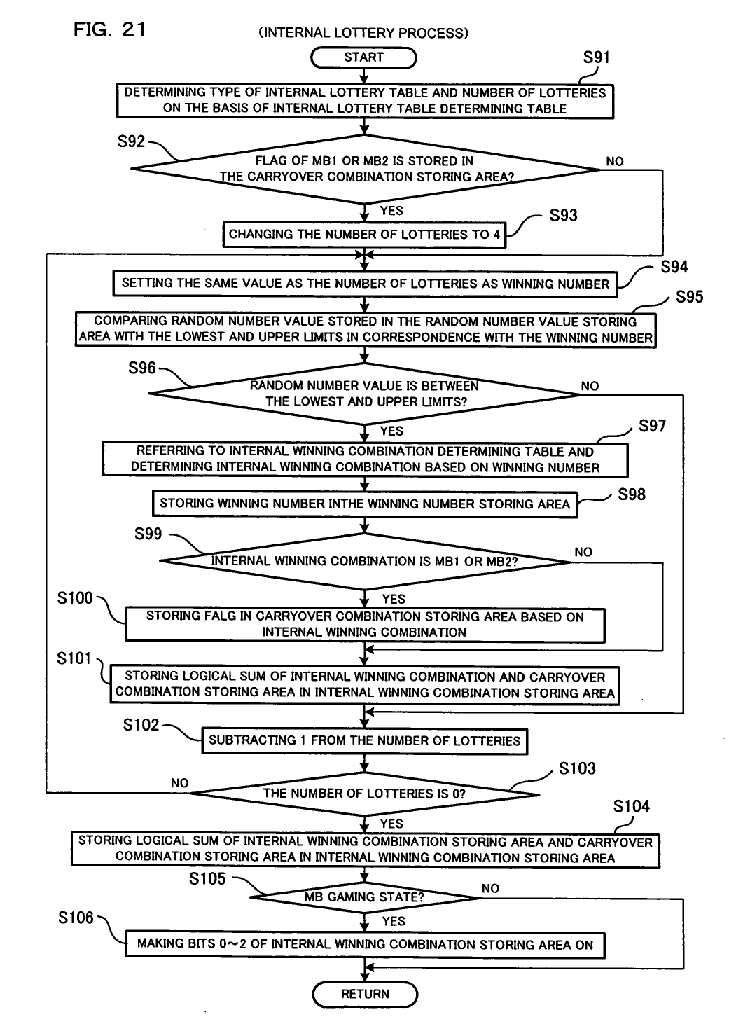

Next, the CPU 31 performs an internal lottery process which will be described later with reference to FIG. 21 (step S6). In the internal lottery process, it is carried out a process of determining an internal winning combination and the like. In addition, the internal lottery process constitutes a part of the internal winning combination determination means.

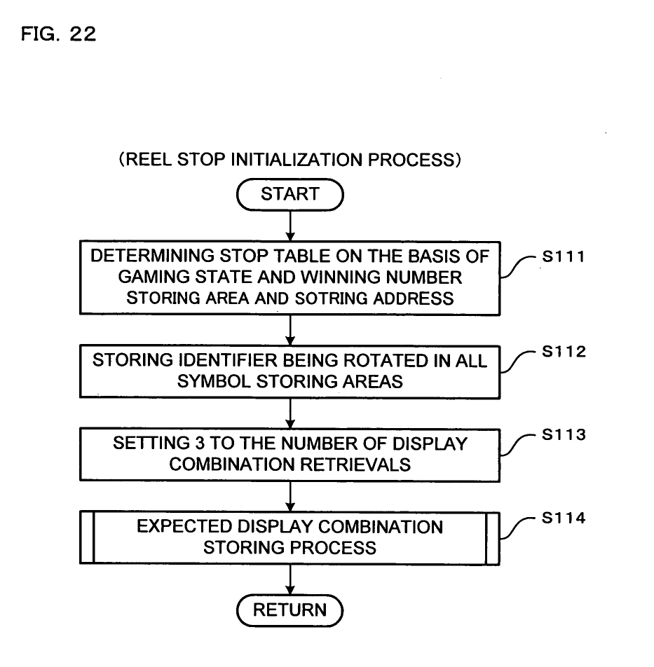

Next, the CPU 31 carries out a reel stop initialization process which will be described later with reference to FIG. 22 (step S7). In the reel stop initialization process, it is performed a process of determining a stop table and the like.

Next, the CPU 31 transmits a start command to the sub-control circuit 72 (step S8). The start command contains data such as internal winning combination, gaming state and the like.

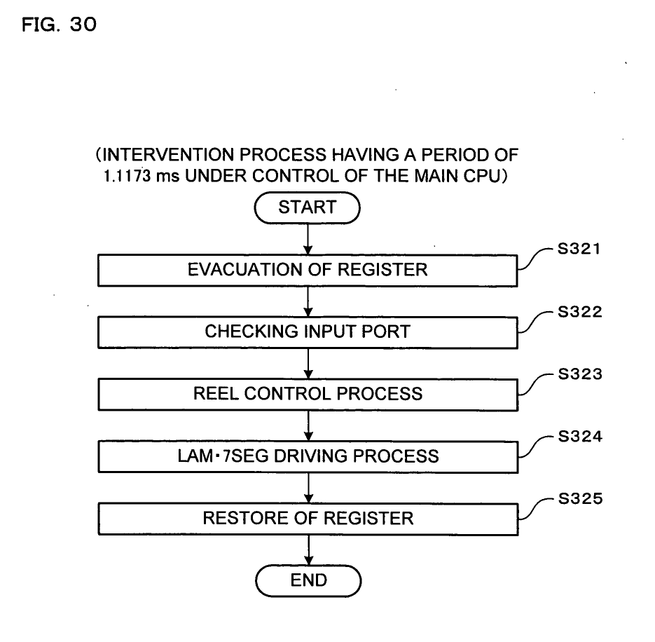

Next, the CPU 31 requests rotation start of all the reels (step S9). In addition, in this process, the CPU 31 activates a push operation of a stop button. When it is requested the rotation start of all the reels, it is performed a process of starting to rotate the reels in the intervention process (see FIG. 30) which will be described later.

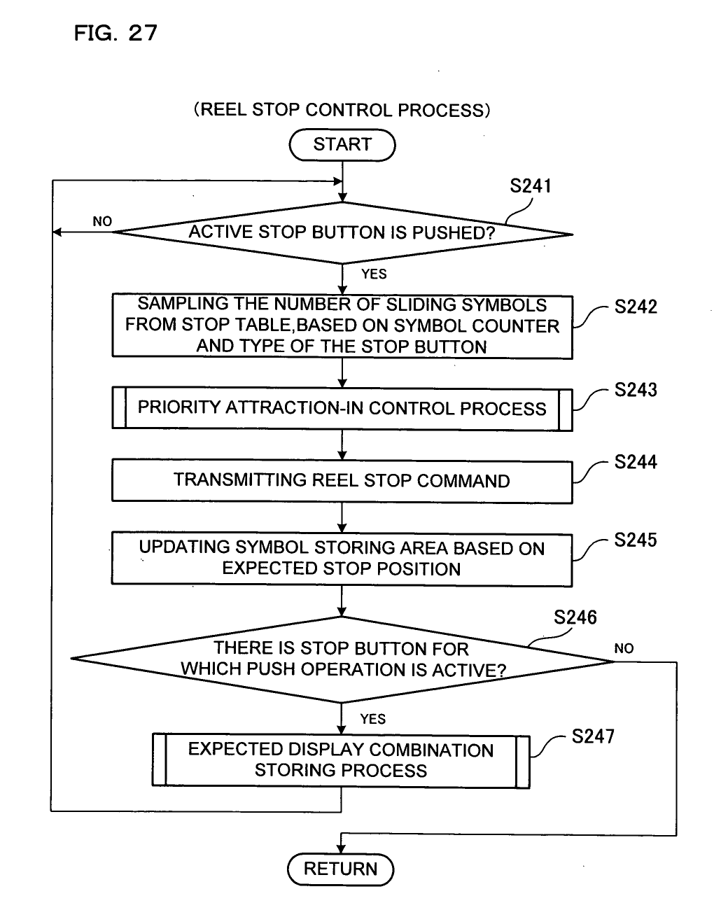

Next, the CPU 31 executes a reel stop control process which will be described later with reference to FIG. 27 (step S10). In the reel stop control process, it is carried out a process of stopping the rotations of the reels 3L, 3C, 3R. In addition, the reel stop control process constitutes a part of the reel stop means.

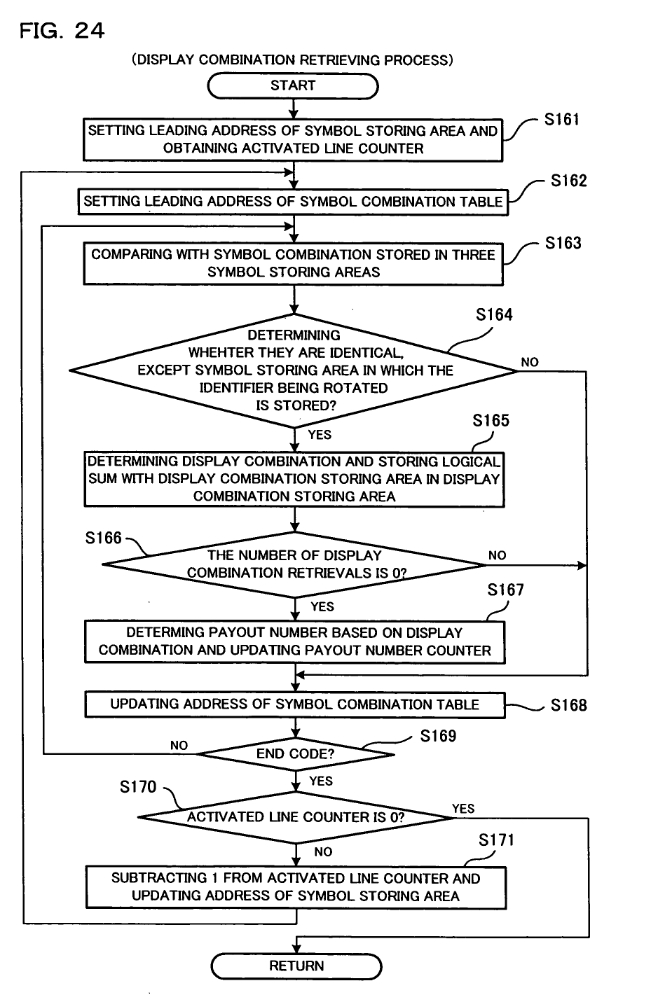

Next, the CPU 31 carries out a display combination retrieving process which will be described later with reference to FIG. 24 (step S11). In this display combination retrieving process, the data stored in the symbol storing area is referred and it is performed a process of determining a type of a display combination and a payout number, based on the symbol combination table. In addition, the display combination retrieving process of the step S11 constitutes a part of the winning determination means for determining whether a winning is achieved or not, on the basis of the combination of symbols displayed by the symbol display means.

Next, the CPU 31 transmits a display combination command to the sub-control circuit 72 (step S12). The display combination command contains data such as display combination achieved and the like.

Next, the CPU 31 carries out a medal payout process (step S13). Specifically, the CPU 31 controls the hopper 40 or updates the credit counter, based on the payout number determined in the step S11.

Next, the CPU 31 updates a bonus end number counter based on the payout number (step S14). Specifically, the CPU 31 subtracts a value corresponding to the payout number from the corresponding counter, on condition that the bonus end number counter is 1. The bonus end number counter is a counter for counting the total number of medals to be paid out to the player, from after the MB operation starts until it is over. When the MB operation starts, 250 is stored and the determined payout number is subtracted every unit game.

Next, the CPU 31 determines whether the flag under MB operation is ON (step S15). If it is determined that the flag under MB operation is ON, the CPU 31 carries out a bonus end checking process (step S16). Specifically, the CPU 31 determines whether the bonus end number counter is 0 or not and clears the flag under MB operation when it is determined that the corresponding counter is 0. In addition, the bonus end checking process constitutes a part of means for ending an operation of a gaming state advantageous to the player.

After the step S16 or when it is determined that the flag under MB operation is not ON in the step of S15, the CPU 31 carries out the bonus operation checking process (step S17). Specifically, the CPU 31 determines whether the display combination is one of MB1 and MB2 or not. If it is determined that one of MB1 and MB2 is the display combination, the CPU makes the flag under MB operation ON, stores 250 in the bonus end number counter and clears the internal carryover combination storing area. In addition, the bonus operation checking process constitutes a part of means for performing an operation of a gaming state advantageous to the player.

Like this, the CPU 31 executes the steps S2 to S17 as processes in a unit game. When the step S17 is over, the CPU proceeds to the step S2 so as to carry out the processes in a next unit game.

In the followings, a medal receiving.start checking process is described with reference to FIG. 20.

First, the CPU 31 determines whether it is an insertion process or not (step S51). Specifically, the CPU 31 determines that it is the insertion process when the medal sensor 22S or the BET switches 11S, 12S, 13S are ON. In addition, in case that the BET switches 11S, 12S, 13S are ON, based on types of the BET switches 11S, 12S, 13S, an insertion number counter for counting the insertion number and a credit counter for counting the number of medals credited, the CPU 31 calculates a value to be added to the insertion number counter for counting the insertion number.

If it is determined as the insertion process in the step S51, the CPU 31 updates the insertion number counter (step S52). In addition, in this process, when it is prohibited the addition of the insertion number counter, the CPU 31 updates the credit counter instead of the insertion number counter.

In addition, although not shown, the CPU 31 determines whether an automatic insertion counter is 0 or not, before the step S51. When it is determined that the corresponding counter is not 0, the CPU carries out a process of copying the corresponding counter to the insertion number counter and prohibits the addition of the insertion number counter after that. The automatic insertion counter is data for discriminating whether the replay is achieved in a previous unit game or not and specifying the insertion number in the previous unit game.

Next, the CPU 31 stores 5 in an activated line counter (step S53). The activated line counter is data for specifying the number of activated lines. In this embodiment, 5 is stored in the activated line counter irrespective of the value of the insertion number counter. Thereby, it is not necessary to provide stop tables which are different in correspondence with the size of the insertion number.

Next, the CPU 31 transmits a BET command to the sub-control circuit 72 (step S54). The BET command contains data of insertion number and the like.

After the step S54 or when it is determined that it is not the insertion process in the step S51, the CPU 31 determines whether the insertion number counter is 3 or not, (step S55). The CPU 31 proceeds to the step S51 when it is determined that the insertion number counter is not 3.

The CPU 31 determines whether the start lever 6 has been subject to the inclination moving operation, when it is determined that the insertion number counter is 3 in the step S55 (step S56). The CPU 31 proceeds to the step S51 when it is determined that the start lever 6 has not been subject to the inclination moving operation. In addition, the CPU 31 ends the medal receiving.start checking process and proceeds to the step S4 of FIG. 19, when it is determined that the start lever 6 has been subject to the inclination moving operation.

In the followings, an internal lottery process is described with reference to FIG. 21.

First, the CPU 31 determines a type of the internal lottery table and the number of lotteries, based on the gaming state and the internal lottery table determining table (step S91).

Next, the CPU 31 determines whether a flag of any one of MB1 and MB2 is stored in the internal carryover combination storing area (step S92). The CPU 31 changes the number of lottery to 4 when it is determined that a flag of any one of MB1 and MB2 is stored in the internal carryover combination storing area (step S93). Thereby, when there is an internal carry over combination in the normal gaming state, the number of lotteries determined to be 6 times is changed to 4 times and MB1 or MB2 is not determined duplicately.

After the step S93 or when it is determined that a flag of any one of MB1 and MB2 is not stored in the internal carryover combination storing area in the step S92, the CPU 31 sets a same value as the number of lotteries, as a winning number (step S94).

Next, the CPU 31 compares the random number value stored in the random number value storing area with the lowest and upper limits in correspondence with the winning number (step S95). Then, the CPU 31 determines whether the random number value is between the lowest limit and the upper limit (step S96).

When it is determined that the random number value is between the lowest limit and the upper limit, the CPU 31 refers to the internal winning combination determining table and determines an internal winning combination based on the set winning number (step S97).

Next, the CPU 31 stores the set winning number in a winning number storing area of the RAM 33 (step S98). The winning number storing area has an initial value of 0 and is structured in such a way that it is sequentially overwritten as this process is carried out. In addition, since the winning number is retrieved from the larger value in descending power, the winning number having a smaller value is preferentially stored in case that the winning number is duplicately determined.

Next, the CPU 31 determines whether the internal winning combination is one of MB1 and MB2 (step S99). When it is determined that the internal winning combination is one of MB1 and MB2, the CPU 31 stores the flag in the internal carryover combination storing area, based on the internal winning combination (step S100).

After the step S100 or when it is determined that the internal winning combination is not one of MB1 and MB2 in the step S99, the CPU 31 stores a logical sum of the internal winning combination and the internal carryover combination storing area in the internal winning combination storing area (step S101). For example, in case that MB1 is carried over, if Bell has been determined, the data of the internal winning combination storing area is “00100010”.

After the step S101 or when it is determined that the random number value is not between the lowest limit and the upper limit in the step S96, the CPU 31 subtracts 1 from the number of lotteries (step S102).

Next, the CPU 31 determines whether the number of lotteries is 0 or not (step S103). The CPU 31 proceeds to the step S94 when it is determined that the number of lotteries is not 0.

The CPU 31 stores a logical sum of the internal winning combination and the internal carryover combination storing area in the internal winning combination storing area, when it is determined that the number of lotteries is 0 (step S104). As a result of this process, if the data of the internal winning combination storing area is “00000000”, a so-called losing is made.

Next, the CPU 31 determines whether it is under MB gaming state or not (step S105). When it is determined that it is not under MB gaming state, the CPU 31 ends the internal lottery process and proceeds to the step S7 of FIG. 19.

When it is determined that it is under MB gaming state in the step S105, the CPU 31 makes the bits 0˜2 of the internal winning combination storing area ON (step S106). In other words, in the MB gaming state, the flags of Cherry, Bell and Watermelon are stored in the internal winning combination storing area, irrespective of the type of the determined winning number (i.e., irrespective of the lottery result by the internal lottery table). Accordingly, in the MB gaming state, it is possible to display the combination of symbols relating to Cherry, Bell and Watermelon on the activated line. In this process, the data stored in the internal winning combination storing area, i.e. “ ”00000111 can be referred to as “complex combination”, for convenience sake of explanations. When this process is over, the CPU ends the internal lottery process and proceeds to the step S7 of FIG. 19.

Hereinafter, the reel stop initialization process is described with reference to FIG. 22.

First, the CPU 31 refers to the stop table determining table, determines a stop table on the basis of the gaming state and the winning number storing area and stores an address (step S111). In addition, the process of step S111 constitutes a part of the stop table determining means for determining one of the plural stop tables memorized by the stop table memory means.

Next, the CPU 31 stores an identifier being rotated in all the symbol storing areas (step S112). Specifically, the CPU 31 makes all the bits of the all the symbol storing areas ON.

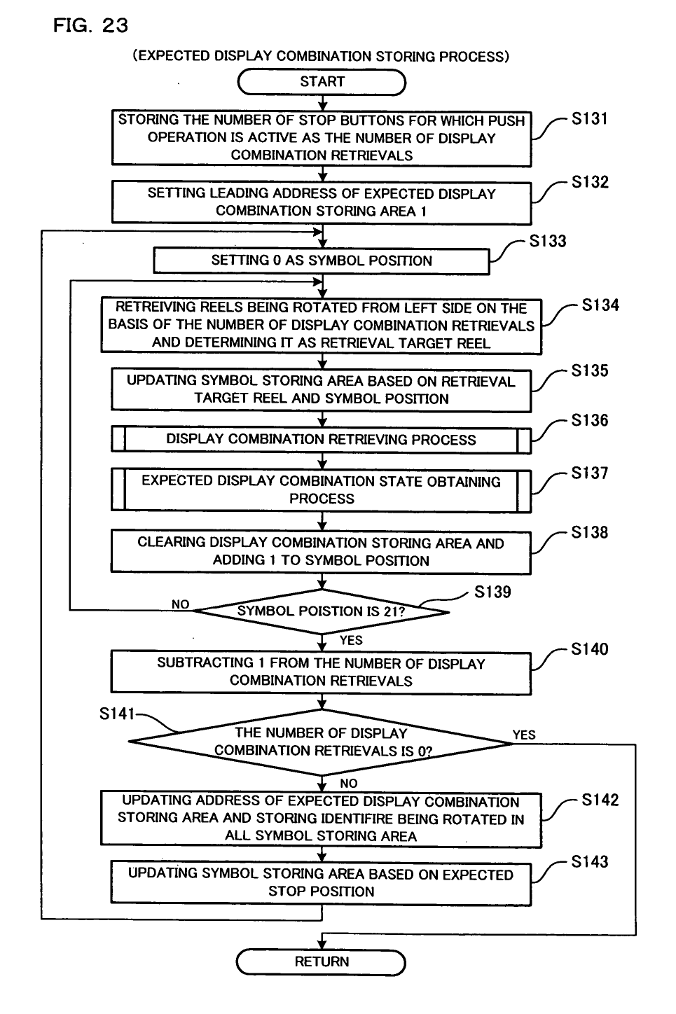

Next, the CPU 31 sets 3 as the number of display combination retrievals (step S113). Subsequently, the CPU carries out an expected display combination storing process which will be described later with reference to FIG. 23 (step S114). In the expected display combination storing process of the step S113, before all the reels start to rotate, it is performed a process of determining a priority attraction-in status in correspondence with the symbols of the symbol positions “0”˜“20” of the respective reels 3L, 3C, 3R. When this process is over, the CPU ends the reel stop initialization process and proceeds to the step S58 of FIG. 19.

In the followings, an expected display combination storing process is described with reference to FIG. 23. In addition, the expected display combination storing process constitutes a part of the priority ranking determination means.

First, the CPU 31 stores the number of the stop button for which the push operation is active as the number of display combination retrievals (step S131). In case of the expected display combination storing process called from the reel stop initialization process, 3 is stored as the number of the display combination retrievals.

Next, the CPU 31 sets a leading address of the expected display combination storing area 1 (step S132). Specifically, a leading address of the symbol position “0” of the expected display combination storing area 1 is set. Then, the CPU 31 sets “0” as the symbol position (step S133).

Next, the CPU 31 retrieves the reel being rotated from the right side on the basis of the number of display combination retrievals and determines it as a retrieval target reel (step S134). Specifically, all the reels being rotated are retrieved, and in order of the left reel 3L, the center reel 3C and the right reel 3R, i.e., from the reel which is being rotated and nearer at the left side, the reels are sequentially determined as a retrieval target reel. For example, if the number of display combination retrievals is 3, the left reel 3L is determined first of all.

Next, the CPU 31 updates the symbol storing area based on the retrieval target reel and the symbol position (step S135). Specifically, based on the retrieval target reel, the symbol position and the symbol arrangement table, a type of the symbol of the corresponding symbol position and a type of the symbols of the symbol positions adjacent to the corresponding symbol position are stored in the symbol storing area.

Next, the CPU 31 carries out a display combination retrieving process which will be described with reference to FIG. 24 (step S136). In the display combination retrieving process, it is performed a process of expecting a display combination, i.e., retrieving a combination of symbols which may be displayed on the activated lines 8a˜8e, for each symbol of each symbol position, based on the symbol storing area and the symbol combination table.

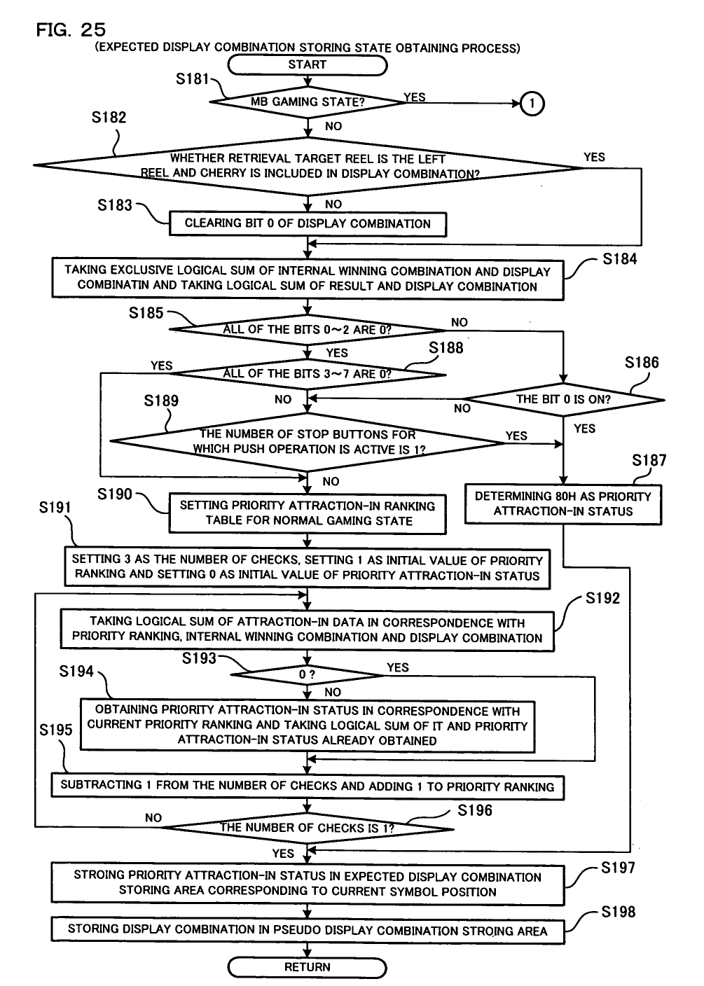

Next, the CPU 31 performs an expected display combination state obtaining process which will be described later with reference to FIG. 25 (step S137). In the expected display combination state obtaining process, it is carried out a process of determining a priority attraction-in status every symbol of each symbol position, based on the expectation of the display combination performed in the display combination retrieving process.

Next, the CPU 31 clears the display combination storing area and adds 1 to the symbol position (step S138). Then, the CPU 31 determines whether the symbol position is 21 or not (step S139). When it is determined that the symbol position is not 21, the CPU 31 proceeds to the step S134.

When it is determined that the symbol position is 21 in the step S139, the CPU 31 subtracts 1 from the number of display combination retrievals (step S140). Then, the CPU 31 determines whether the number of display combination retrievals is 0 or not (step S141). When it is determined that the number of display combination retrievals is 0, the CPU ends the expected display combination storing process and proceeds to the step S8 of FIG. 19 or a step S241 of FIG. 27 which will be described later.

When it is determined that the number of display combination retrievals is not 0, the CPU 31 updates the address of the expected display combination storing area and stores the identifier being rotated in all the symbol storing areas (step S142). The update of the address of the expected display combination storing area is carried out in order of the expected display combination storing area 1, the expected display combination storing area 2 and the expected display combination storing area 3.

Next, the CPU 31 updates the symbol storing area based on an expected stop position (step S143). Specifically, the CPU updates the symbol storing area based on the symbol counter of the stopped reel and the symbol arrangement table. When this process is over, the CPU proceeds to the step S133.

In the followings, a display combination retrieving process is described with reference to FIG. 24.

First, the CPU 31 sets a leading address of the symbol storing area and obtains an activated line counter (step S161). Specifically, an address in correspondence with the center line 8c is set and 5 is obtained as the activated line counter.

Next, the CPU 31 sets a leading address of the symbol combination table (step S162). Specifically, an address corresponding to Cherry is set.

Next, the CPU 31 compares it with the combinations of symbols stored in the three symbol storing areas (step S163). In other words, the combinations of symbols which are stored in the symbol storing area corresponding to the left reel 3L, the symbol storing area corresponding to the center reel 3C and the symbol storing area corresponding to the right reel 3R and the combination of symbols corresponding to a current address of the symbol combination table are compared.

Next, the CPU 31 determines whether they are identical or not, except the symbol storing area in which the identifier being rotated is stored (step S164). When it is determined that they are identical, except the symbol storing area in which the identifier being rotated is stored, the CPU 31 determines a display combination and stores a logical sum of the display combination and the display combination storing area in the display combination storing area (step S165).

Next, the CPU 31 determines whether the number of display combination retrievals is 0 or not (step S166). When it is determined that the number of display combination retrievals is 0, the CPU 31 refers to the symbol combination table, determines a payout number based on the determined display combination and updates the payout number counter (step S167).

After the step S167, when it is determined that they are not identical, except the symbol storing area in which the identifier being rotated is stored in the step S164, or when it is determined that the number of display combination retrievals is not 0 in the step S166, the CPU 31 updates the address of the symbol combination table (step S168). The corresponding address is updated in order of Cherry, Bell, Watermelon, Replay, MB2 and MB1, and updated to end code when it is completed the check of the combination of all symbols.

Next, the CPU 31 determines whether it is an end code or not (step S169). When it is determined that it is not the end code, the CPU 31 proceeds to the step S163.

When it is determined that it is the end code in the step S169, the CPU 31 determines whether the activated line counter is 0 or not (step S170). When it is determined that the activated line counter is 0, the CPU 31 ends the display combination retrieving process and proceeds to the step S137 of FIG. 23 or the step S12 of FIG. 19.

When it is determined that the activated line counter is not 0 in the step S170, the CPU 31 subtracts 1 from the activated line counter and updates the address of the symbol storing area (step S171). The corresponding address is updated in order of the center line 8c, the top line 8b, the bottom line 8d, the cross-down line 8e and the cross-up line 8a. When this process is over, the CPU proceeds to the step S162.

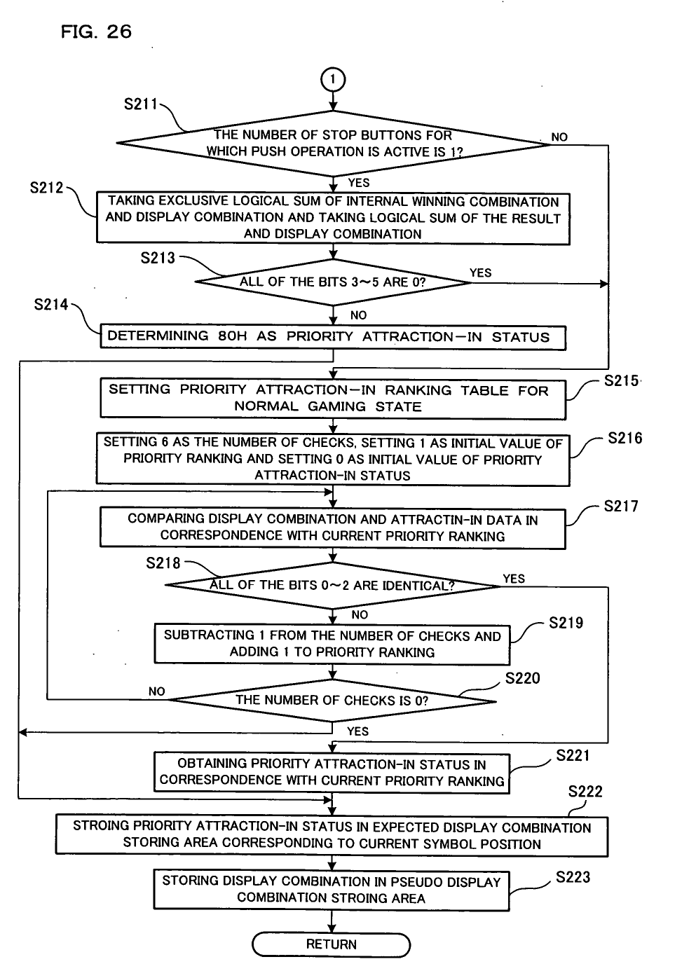

In the followings, an expected display combination state obtaining process is described with reference to FIGS. 25 and 26.

First, the CPU 31 determines whether it is under MB gaming state (step S181). When it is determined that it is not under MB gaming state, the CPU 31 determines whether the retrieval target reel is the left reel and Cherry is included in the display combination (step S182). When it is not determined that the retrieval target reel is the left reel and Cherry is included in the display combination, the CPU 31 clears the bit 0 of the display combination (step S183). In other words, this is because Cherry is related to the left reel 3L only.

After the step S183, or when it is determined that the retrieval target reel is the left reel and Cherry is included in the display combination in the step S182, the CPU 31 takes an exclusive logical sum of the internal winning combination and the display combination and then takes a logical product of the result and the display combination (step S184). The corresponding process is carried out, so that it is determined whether there is a bit which is ON in the display combination storing area only. From this, it is determined whether the display combination is included in the internal winning combination, i.e., whether the symbol position at this point satisfies the internal winning combination determined.

Next, the CPU 31 determines whether all the bits 0˜2 are 0 or not (step S185). When it is determined that all the bits 0˜2 are not 0, the CPU 31 determines whether the bit 0 is ON or not (step S186). When it is determined that the bit 0 is ON, the CPU 31 determines 80H as a priority attraction-in status (step S187). In other words, the priority attraction-in status is determined as “10000000” representing the stop prohibition.

When it is determined that all the bits 0˜2 are 0 in the step S185, the CPU determines whether all the bits 3˜7 are 0 or not (step S188). When it is determined that all the bits 3˜7 are not 0, or when it is determined that the bit 0 is not ON in the step S186, the CPU 31 determines whether the number of stop buttons for which the push operation is active is 1 or not (step S189). When it is determined that the number of stop buttons for which the push operation is active is 1, the CPU proceeds to the step S187.

When it is determined that the number of stop buttons for which the push operation is active is not 1 in the step S189, or when all the bits 3˜7 are 0 in the step S188, the CPU 31 sets a priority attraction-in ranking table for the normal gaming state (step S190). Then, the CPU 31 sets 3 as the number of checks, sets 1 as an initial value of the priority ranking and sets 0 as an initial value of the priority attraction-in status (step S191).

Next, the CPU 31 takes a logical product of attraction-in data corresponding to the current priority ranking, the internal combination and the display combination (step S192). Then, the CPU 31 determines whether the logical product is 0 or not (step S193). When it is determined that the logical product is not 0, the CPU 31 obtains a priority attraction-in status corresponding to the current priority ranking and takes a logical sum of it and the priority attraction-in status already obtained (step S194).

After the step S194, or when it is determined that the logical product is 0 in the step S193, the CPU 31 subtracts 1 from the number of checks and adds 1 to the priority ranking (step S195). Then, the CPU 31 determines whether the number of checks is 0 or not (step S196). When it is determined that the number of checks is not 0, the CPU proceeds to the step S192.

When it is determined that the number of checks is 0 in the step S196, or after the step S187, the CPU 31 stores the priority attraction-in status in the expected display combination storing area corresponding to the current symbol position (step S197). Then, the CPU 31 stores the display combination in the pseudo display combination storing area (step S198). When this process is over, the CPU ends the expected display combination state obtaining process and proceeds to the step S138 of FIG. 23.

When it is determined that it is under MB gaming state in the step S181, the CPU 31 determines whether the number of stop buttons for which the push operation is active is 1 or not (step S211 of FIG. 26). When it is determined that the number of stop buttons for which the push operation is active is 1, the CPU 31 takes an exclusive logical sum of the internal winning combination and the display combination and then takes a logical product of the result and the display combination (step S212).

Next, the CPU 31 determines whether all the bits 3˜5 are 0 or not (step S213). When it is determined that all the bits 3˜5 are not 0, the CPU 31 sets 80H as the priority attraction-in status (step S214). In other words, “10000000” representing the stop prohibition is set as the priority attraction-in status .

When it is determined that all the bits 3˜5 are 0, or when it is determined that the number of stop buttons for which the push operation is active is not 1, the CPU 31 sets a priority attraction-in ranking table for the MB gaming state (step S215).

Next, the CPU 31 sets 6 as the number of checks, sets 1 as an initial value of the priority ranking, and sets 0 as an initial value of the priority attraction-in status (step S216). Then, the CPU 31 compares the display combination and the attraction-in data in correspondence with the current priority ranking (step S217). Next, the CPU 31 determines whether all the bits 0˜2 are identical or not (step S218).

When it is determined that all the bits 0˜2 are not identical in the step S218, the CPU 31 subtracts 1 from the number of checks and adds 1 to the priority ranking (step S219). Then, the CPU 31 determines whether the number of checks is 0 or not (step S220). When it is determined that the number of checks is not 0, the CPU proceeds to the step S217.

When it is determined that all the bits 0˜2 are identical in the step S218, the CPU 31 obtains the priority attraction-in status in correspondence with the current priority ranking (step S221).

After the step S221, after the step S214 or when it is determined that the number of checks is 0 in the step S220 (in this case, the priority attraction-in status is 0), the CPU 31 stores the priority attraction-in status in the expected display combination storing area corresponding to the current symbol position, (step S222). In addition, the step S222 (or the step S197) constitutes a part of means for determining the priority attraction-in ranking on the basis of the type of the corresponding symbol, the type of symbols adjacent to the corresponding symbol and the type of the determined internal winning combination, for each symbol arranged on the periphery of each reel. In addition, the expected display combination storing area constitutes a part of the priority ranking memory means for memorizing the priority attraction-in ranking of each symbol arranged on the periphery of each reel.

Next, the CPU 31 stores the display combination in the pseudo display combination storing area (step S223). When this process is over, the CPU ends the expected display combination obtaining process and proceeds to the step S138 of FIG. 23.

In the followings, a reel stop control process is described with reference to FIG. 27.

First, the CPU 31 determines whether the active stop button has been pushed (step S241). When it is determined that the active stop button has not been pushed, the CPU 31 repeats the step S241. In addition, while determining whether the active stop button has been pushed, the CPU 31 may determine whether a predetermined time (for example, 30 sec) has lapsed after the start switch 6S has been ON (for performing a so-called automatic stop).

When it is determined that the active stop button has been pushed in the step S241, the CPU 31 specifies a type of the corresponding stop button, annuls a push operation after the corresponding stop button has been pushed and samples the number of sliding symbols from the stop table on the basis of the symbol counter and the type of the stop button (step S242). In addition, the process in the step S242 constitutes a part of the means for obtaining the number of sliding symbols.

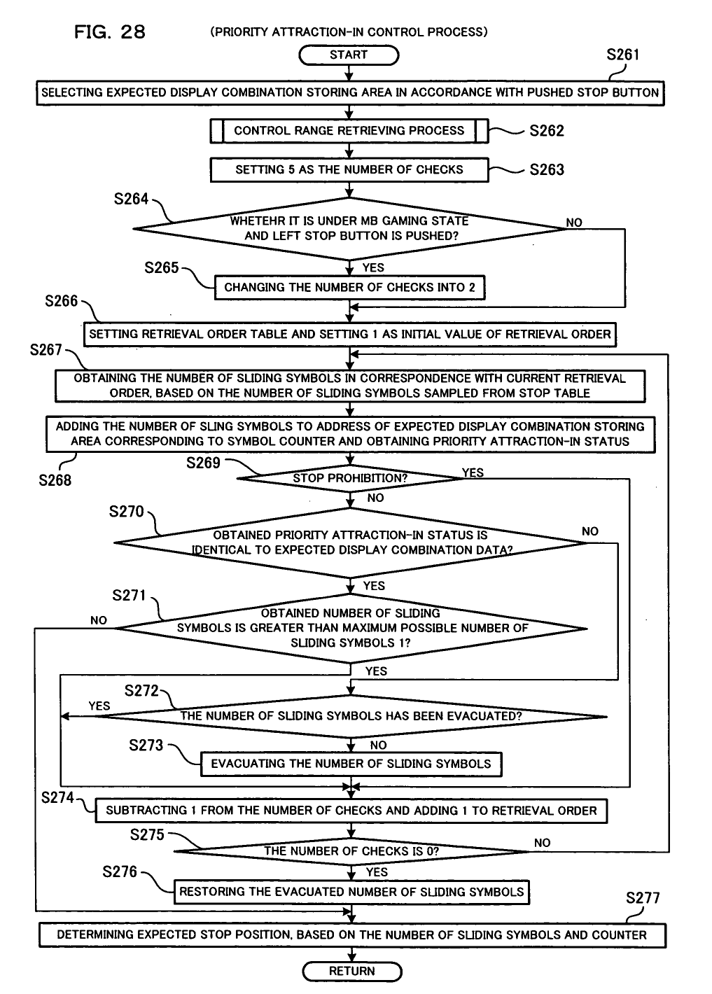

Next, the CPU 31 carries out a priority attraction-in control process (step S243) which will be described later with reference to FIG. 28. In addition, the priority attraction-in control process constitutes a part of the priority ranking determination means.

Next, the CPU 31 transmits the reel stop command to the sub-control circuit 72 (step S244). The reel stop command contains the data such as type of the stopped reel and the like.

Then, the CPU 32 updates the symbol storing area, based on the expected stop position (step S245). In other words, an identifier of the symbol displayed on the activated line regarding the stopped reel is stored in all the symbol storing areas.

Next, the CPU 31 determines whether there is a stop button for which the push operation is active (step S246). When it is determined that there is not a stop button for which the push operation is active, the CPU ends the reel stop control process and proceeds to the step S11 of FIG. 19.

When it is determined that there is a stop button for which the push operation is active in the step S246, the CPU 31 performs the expected display combination storing process (see FIG. 23) (step S247). When this process is over, the CPU proceeds to the step S241.

In the followings, a priority attraction-in control process is described with reference to FIG. 28.

First, the CPU 31 selects an expected display combination storing area in accordance with the pushed stop button (step S261). For example, in case that the left reel 3L is pushed as a first stop operation, the expected display combination storing area 1 is selected.

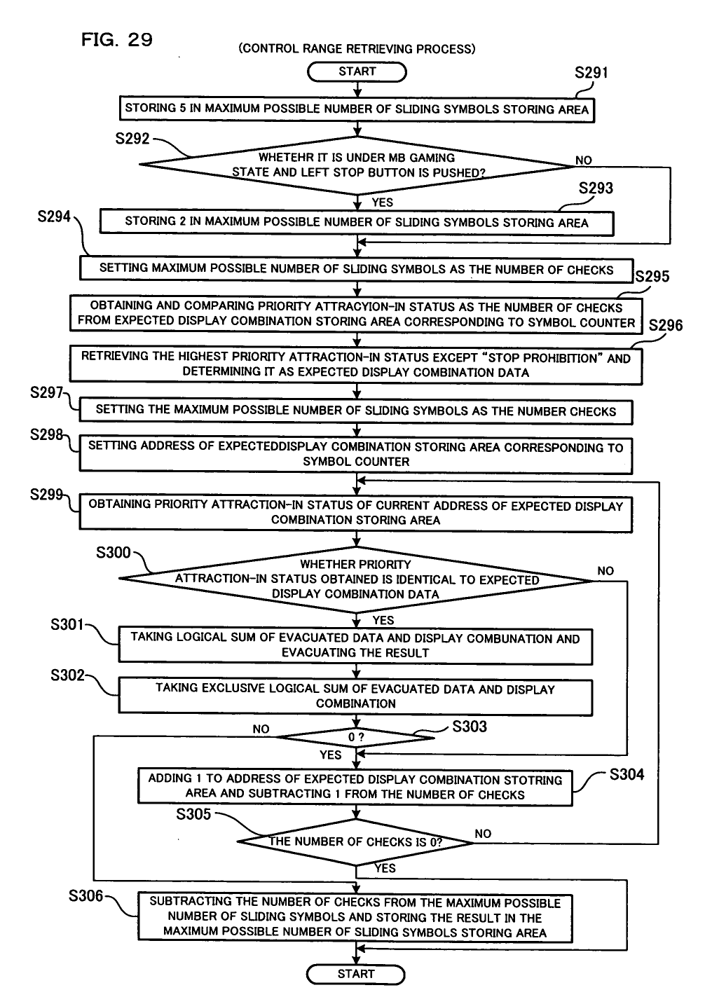

Next, the CPU 31 performs a control range retrieving process which will be described later with reference to FIG. 29 (step S262). In addition, the control range retrieving process constitutes a part of the means for determining the maximum possible number of sliding symbols.

Next, the CPU 31 sets 5 as the number of checks (step S263). Then, the CPU 31 determines whether it is under MB gaming state and the left stop button has been pushed (step S264). When it is determined that it is under MB gaming state and the left stop button has been pushed, the CPU 31 changes the number of checks into 2 (step S265).

After the step S265 or when it is not determined that it is under MB gaming state and the left stop button has been pushed in the step S264, the CPU 31 sets the retrieval order table and sets 1 as an initial value of the retrieval order (step S266).

Next, the CPU 31 obtains the number of sliding symbols in correspondence with the current retrieval order, based on the number of sliding symbols sampled from the stop table (step S267). In addition, the process in the step S267 constitutes a part of the means for obtaining the number of sliding symbols.

Next, the CPU 31 adds the number of sliding symbols to the address of the expected display combination storing area corresponding to the symbol counter and obtains the priority attraction-in status (step S268).

Next, the CPU 31 determines whether the obtained priority attraction-in status is a stop prohibition (step S269). When it is determined that the obtained priority attraction-in status is not a stop prohibition, the CPU 31 determines whether the obtained priority attraction-in status is same as the expected display combination data (step S270). In addition, the process in the step S270 constitutes a part of priority ranking comparing means for comparing the priority attraction-in ranking of the symbol in accordance with the number of sliding symbols obtained by the means for obtaining the number of sliding symbols with a priority attraction-in ranking determined by the priority ranking determination means. When it is determined that the obtained priority attraction-in status is same as the expected display combination data in the step S270, the CPU 31 determines whether the number of sliding symbols obtained is greater than a value obtained by subtracting 1 from the maximum possible number of sliding symbols (step S271). In addition, the process in the step S271 constitutes a part of number of sliding symbols comparing means for comparing the number of sliding symbols obtained by the means for obtaining the number of sliding symbols with the maximum possible number of sliding symbols determined by the means for determining the maximum possible number of sliding symbols.

When it is determined that the obtained priority attraction-in status is not same as the expected display combination data in the step S270, the CPU 31 determines whether the number of sliding symbols has been evacuated (step S272). When it is determined that the number of sliding symbols has not been evacuated, the CPU 31 evacuates the number of sliding symbols (step S273).

After the step S273, when it is determined that the number of sliding symbols has been evacuated in the steps S272, when it is determined that the number of sliding symbols obtained in the step S271 is greater than a value obtained by subtracting 1 from the maximum possible number of sliding symbols, or when it is determined that the obtained priority attraction-in status is a stop prohibition in the step S269, the CPU 31 subtracts 1 from the number of checks and adds 1 to the retrieval order (step S274).

Next, the CPU 31 determines whether the number of checks is 0 or not (step S275). When it is determined that the number of checks is not 0, the CPU 31 proceeds to the step S267. In addition, when it is determined that the number of checks is 0, the CPU 31 restores the evacuated number of sliding symbols (step S276).

After the step S276, or when it is determined that the number of sliding symbols obtained in the step S271 is not greater than a value obtained by subtracting 1 from the maximum possible number of sliding symbols (i.e., the number of sliding symbols obtained in the step S271 is smaller than the maximum possible number of sliding symbols), the CPU 31 determines an expected stop position, based on the number of sliding symbols and the symbol counter (step S277). If the expected stop position is determined, it is carried out a process of stopping the rotation of reel on the basis of the corresponding expected stop position in an intervention process which will be described later (see FIG. 30). In addition, if any one of the number of sliding symbols and the expected stop position is determined, the other is determined. Therefore, it can be said that they have an equivalent relation to each other. When this process is over, the CPU ends the attraction-in control process and proceeds to the step S244 of FIG. 27.

In the followings, a control range retrieving process is described with reference to FIG. 29.

First, the CPU 31 stores 5 in the maximum possible number of sliding symbols storing area (step S291). Next, the CPU 31 determines whether it is under MB gaming state and the left stop button has been pushed (step S292). When it is determined that it is under MB gaming state and the left stop button has been pushed, the CPU 31 stores 2 in the maximum possible number of sliding symbols storing area (step S293).

After the step S293 or when it is not determined that it is under MB gaming state and the left stop button has been pushed, the CPU 31 sets the maximum possible number of sliding symbols as the number of checks (step S294).

Next, the CPU 31 obtains and compares the priority attraction-in status s as the number of checks from the expected display combination storing area corresponding to the symbol counter (step S295). Next, the CPU 31 retrieves the highest priority attraction-in status except the “stop prohibition” and determines it as expected display combination data (step S296). In addition, the process in the step S296 constitutes a part of the priority ranking determination means.

Next, the CPU 31 sets the maximum possible number of sliding symbols as the number of checks (step S297). Next, the CPU 31 sets an address of the expected display combination storing area corresponding to the symbol counter (step S298).

Next, the CPU 31 obtains a priority attraction-in status of a current address of the expected display combination storing area (step S299). Next, the CPU 31 determines whether the priority attraction-in status obtained is identical to the expected display combination data (step S300). When it is determined that the priority attraction-in status obtained is identical to the expected display combination data, the CPU 31 takes a logical sum of the evacuated data and the display combination stored in the pseudo display combination storing area and evacuates the result obtained (step S301). If the display of symbols relating to the internal display combination nearer at the expected stop position is prohibited, there occurs a bit disappearing. This process is carried out to monitor it.

Next, the CPU 31 takes an exclusive logical sum of the evacuated data and the display combination (step S302). Then, the CPU 31 determines whether a result of the exclusive logical sum is 0 or not (step S303).

When it is determined that a result of the exclusive logical sum is 0, or when it is determined that the priority attraction-in status obtained is not identical to the expected display combination data, the CPU 31 adds 1 to the address of the expected display combination storing area and subtracts 1 from the number of checks (step S304).

Next, the CPU 31 determines whether the number of checks is 0 or not (step S305). When it is determined that the number of checks is not 0, the CPU 31 proceed to the step S299. In addition, when it is determined that the number of checks is 0, the CPU ends the control range retrieving process and proceed to the step S263 of FIG. 28.

When it is determined that a result of the exclusive logical sum is not 0 in the step S303, the CPU 31 subtracts the number of checks from the maximum possible number of sliding symbols and stores a result thereof in the maximum possible number of sliding symbols storing area (step S306). In addition, the process in the step S306 constitutes a part of the means for determining maximum possible number of sliding symbols. When this process is over, the CPU ends the control range retrieving process and proceeds to the step S263 of FIG. 28.

In the followings, it is described an intervention process having a period of 1.1173 ms which is carried out under control of the CPU 31 of the main control circuit 71, reference to FIG. 30.

First, the CPU 31 evacuates a register (step S321). Next, the CPU 31 checks an input port (step S322). Specifically, the CPU 31 checks an input of a signal from each switch and the like.

Next, the CPU 31 carries out a reel control process (step S323). Specifically, in case that it has been made the request for the rotation start of the reel, the CPU 31 starts to rotate the reels 3L, 3C, 3R and carries out the rotations at a constant speed. In addition, in case that the expected stop position has been determined, the CPU waits until the symbol counter of the corresponding reel is updated to the same value as the expected stop position, and then slows down and stops the rotation of the corresponding reel. For example, if the symbol counter is “16” and the expected stop position is “19”, the CPU stops the rotation of the reel when symbol counter becomes “19”. In addition, the reel control process constitutes a part of the reel rotation means. Additionally, the reel control process constitutes a part of the reel stop means.

Next, the CPU 31 performs a lamp.7SEG driving process (step S324). Specifically, the CPU 31 turns on the BET lamps 9a, 9b, 9c on the basis of the insertion number counter and displays the payout number on the information display unit 18, etc.

Next, the CPU 31 carries out a restore of the register (step S325). When this process is over, the CPU ends the intervention process having a period of 1.1173 ms.

Hereinafter, operations of the reel stop initialization process (FIG. 22), the expected display combination storing process (FIG. 23), the display combination retrieving process (FIG. 24), the expected display combination state obtaining process (FIGS. 25 and 26), the reel stop control process (FIG. 27), the priority attraction-in control process (FIG. 28) and the control range retrieving process (FIG. 29) will be described with reference to specific examples. In addition, in the following examples, the gaming state is the MB gaming state and the complex combination (i.e., “00000111”) is stored in the internal winning combination storing area.

(Before the Rotations of all the Reels)

First, in the reel stop initialization process, since it is under MB gaming state, it is determined a stop table for the MB gaming state and a leading address thereof is stored.

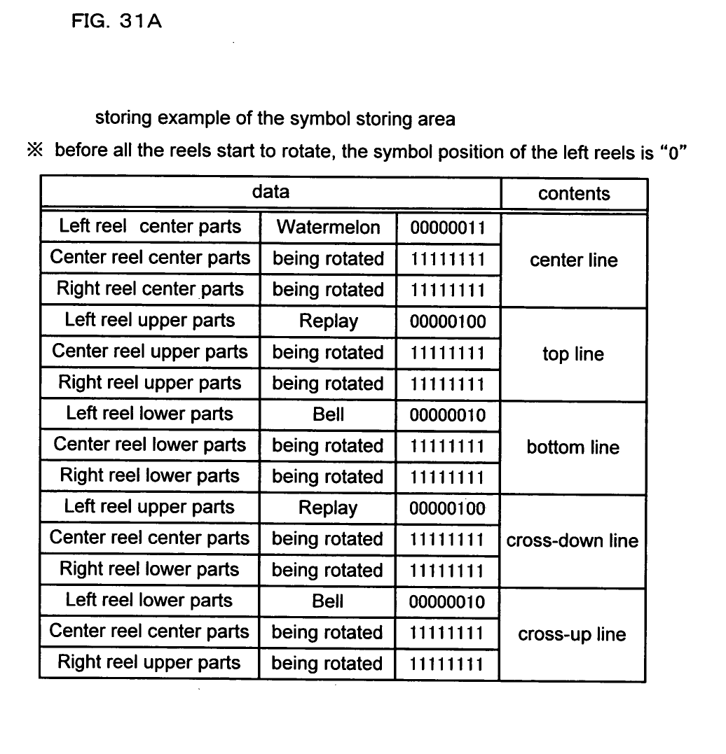

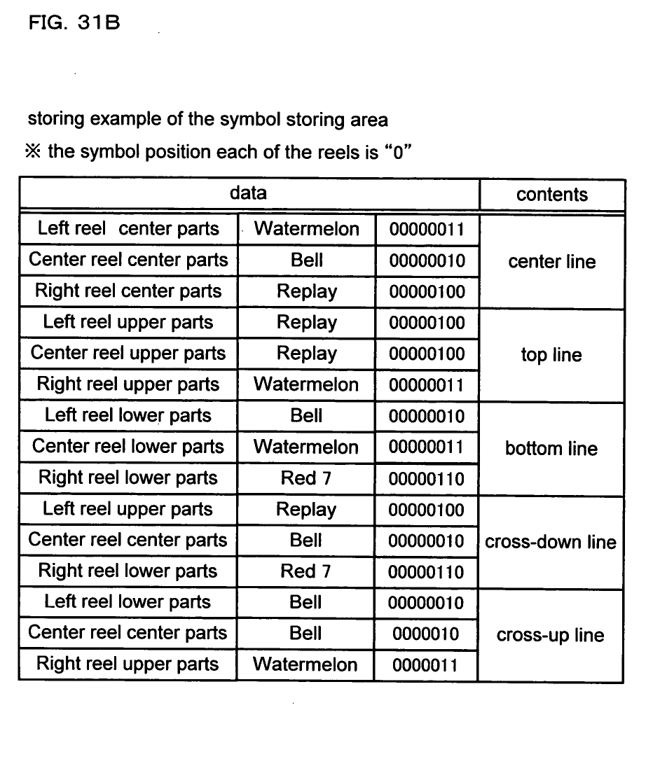

Next, in the expected display combination storing process, the left reel 3L is determined as a retrieval target reel and “0” is set as a symbol position. Based on the type of the retrieval target reel (i.e., left reel 3L), the symbol position (i.e., “0”) and the symbol arrangement table, a type of the symbol is specified (i.e., Watermelon) and an identifier thereof is stored in the symbol storing area which stores symbols of the center part of the left reel 3L. In addition, it is specified a type (i.e., Replay) of a symbol of a symbol position (i.e., “1”) having added 1 to the symbol position “0” and an identifier thereof is stored in the symbol storing area which stores symbols of the upper part of the left reel 3L. In addition, it is specified a type (i.e., Bell) of a symbol of a symbol position (in this case, exceptionally “20”) having subtracted 1 from the symbol position “0” and an identifier thereof is stored in the symbol storing area which stores symbols of the lower part of the left reel 3L. In this case, the symbol storing area is as shown in FIG. 31A.

FIG. 31 shows an example of the symbol storing area. FIG. 31A is a storing example of the case that the symbol position of the left reel 3L is “0”. For the center reel 3C and the right reel 3R which are not a retrieval target, identifiers being rotated is stored. In addition, FIG. 31B is a storing example of a case that the symbol position of each reel 3L, 3C, 3R is “0”, and identifiers of the symbols as shown are stored.

Next, in the display combination retrieving process, a leading address of the symbol combination table is set and a display combination is determined on the basis of the symbol storing area of the center line 8c. In other words, since each identifier of “Watermelon-being rotated-being rotated” is stored in the symbol storing area of the center line 8c, Watermelon is determined as a display combination on the basis of the symbol combination table and “00000100” is stored in the display combination storing area.

Continuing the center line 8c, display combinations are determined in order of the top line 8b, the bottom line 8d, the cross-down line 8e and the cross-up line 8a and a logical sum of the determined display combinations is stored in the display combination storing area. In other words, from the above storing example, Replay is determined as a display combination in the top line 8b and the cross-down line 8e, Bell is determined as a display combination in the bottom line 8d and the cross-up line 8a and “00001110” is stored in the display combination storing area.

Next, in the expected display combination state obtaining process, since the gaming state is the MB gaming state and the number of stop buttons for which the push operation is active is not 1, the display combination and the attraction-in data defined by the priority attraction-in ranking table for the MB gaming state are sequentially compared and it is determined whether all the bits 0˜2 are identical or not (i.e., the bits 3˜7 are excluded from the comparison target).

Herein, in the display combination (i.e., “00001110”) and the attraction-in data having a priority ranking “4” (i.e., “00000110”), since all the bits 0˜2 are identical, the priority attraction-in data (i.e., “00000010”) corresponding to the priority ranking “4” is obtained.

The determined priority attraction-in status is stored in an area corresponding to the symbol position “0”, which is the expected display combination storing area 1. In addition, the display combination is stored in an area corresponding to the symbol position “0”, which is the pseudo display combination storing area.

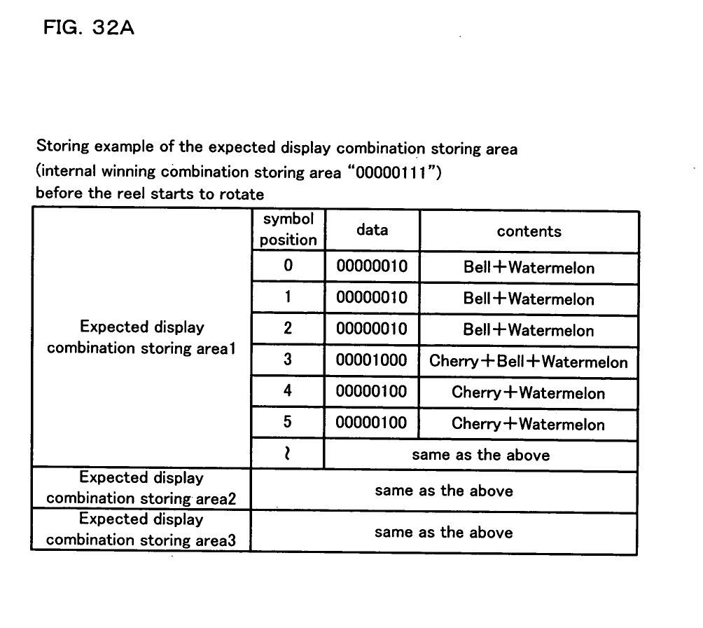

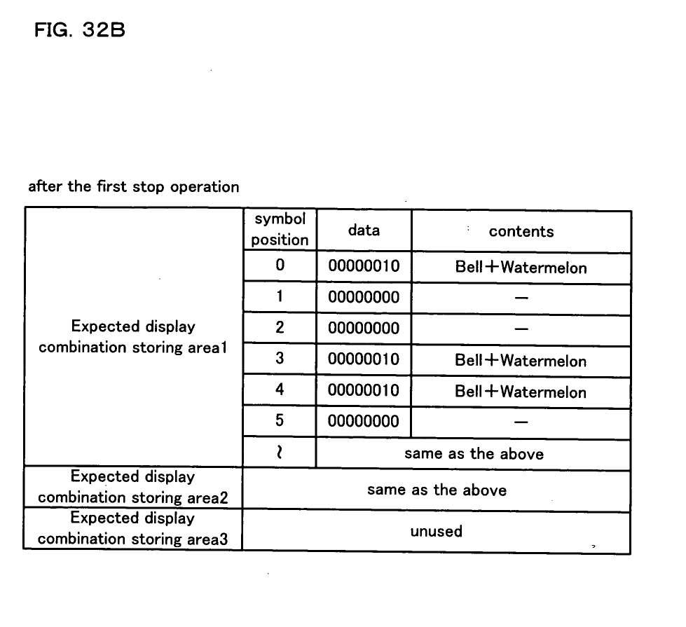

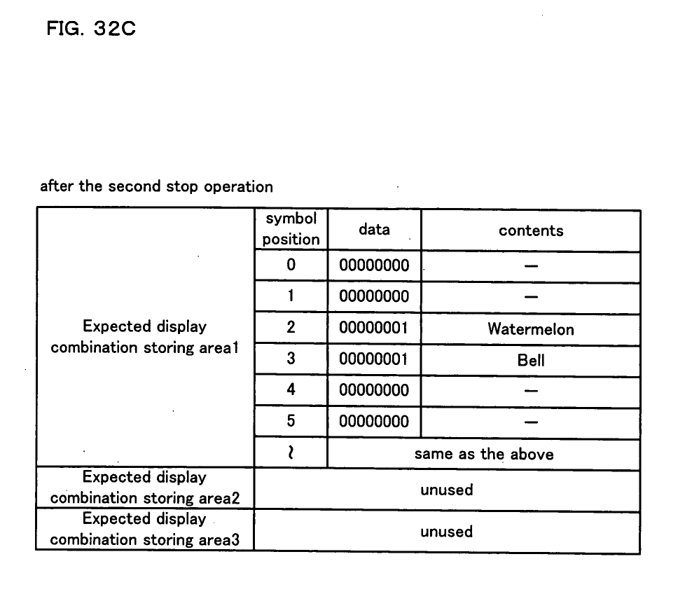

The above process is carried out in correspondence with all the symbol positions “0”˜“20” in all the reels 3L, 3C, 3R and the determined priority attraction-in status s are stored in the expected display combination storing area, as shown in FIG. 32A.

FIG. 32 shows a storing example of the expected display combination storing area. As described above, FIG. 32A is a storing example of expected display combination storing area before the reels 3L, 32C, 3R start to rotate. The expected display combination storing area 1 corresponds to the left reel 3L, the expected display combination storing area 2 corresponds to the center reel 3C and the expected display combination storing area 3 corresponds to the right reel 3R.

(First Stop Operation)

Hereinafter, it will be described a case that a first stop operation is carried out with regard to the left stop button 7L and the symbol counter is “1” when the corresponding left stop button 7L is pushed,.

First, in the reel stop control process, since the left stop button 7L is pushed when the symbol counter is “1”, the corresponding number of sliding symbols “0” is sampled from the stop table for the MB gaming state.

Next, in the priority attraction-in control process, since the first stop operation is the push operation for the left stop button 7L, the expected display combination storing area 1 is selected.

Next, in the control range retrieving process, since it is under MB gaming state and the left stop button 7L is pushed, the maximum possible number of sliding symbols “2” is set as the number of checks. It is obtained priority attraction-in status s (except the stop prohibition) as the number of checks from the address (symbol position “1” corresponds to it) of the expected display combination storing area 1 corresponding to the symbol counter “1” in an address order, and the highest priority attraction-in status is retrieved. Herein (see FIG. 32A), “00000010” of the symbol position “1” and the symbol position “0” is the highest priority attraction-in status and is determined as the expected display combination data.

Since the determined expected display combination data and the priority attraction-in status corresponding to the address (i.e., symbol position “1”) of the current expected display combination storing area 1 are identical, it is taken a logical sum of the display combination (i.e., “00000110”) and the evacuated data (initial value is “0”) and a result thereof (i.e., “00000110”) is evacuated. Then, since it is taken an exclusive logical sum of the evacuated data and the display combination and a result thereof becomes “0”, the number of checks is subtracted by 1 and the address of the expected display combination storing area 1 is advanced by one.

Subsequently, since the expected display combination data and the priority attraction-in status corresponding to the symbol position “2” are identical, it is taken a logical sum of the display combination and the evacuated data (i.e., “00000110”) and a result thereof (i.e., “00000110”) is evacuated. Since it is taken an exclusive logical sum of the evacuated data and the display combination and a result thereof becomes “0”, the number of checks is subtracted by 1 and thus becomes “0”, and the control range retrieving process is over (in addition, it is not performed an update of the maximum possible number of sliding symbols).

Next, it is referred to the number of sliding symbols “0” sampled from the stop table for the MB gaming state, and the retrieval order table, so that it is obtained the number of sliding symbols (i.e., “0”) in correspondence with the current retrieval order (herein, retrieval order “1”).

From the address of the expected display combination storing area 1 corresponding to the symbol counter “1”, it is obtained a priority attraction-in status stored in the previous address (symbol position “1”) added by the number of sliding symbols obtained from the retrieval order table.

Herein, since the obtained priority attraction-in status and the expected display combination data are identical and the number of sliding symbols obtained from the retrieval order table is not greater than a value (i.e., “1”) obtained by subtracting 1 from the maximum possible number of sliding symbols, the corresponding obtained number of sliding symbols (i.e., “0”) is determined as the number of sliding symbols and an expected stop position (i.e., “1”) is determined on the basis of it.

As a result of that, the rotation of the left reel 3L is stopped on the basis of the expected stop position “1”, so that Bell, Replay and Watermelon are displayed on the upper, center and lower parts of the left display window 4L, respectively.

(After First Stop Operation)

When the rotation of the left reel 3L is stopped, with regard to the center reel 3C and the right reel 3R corresponding to the stop buttons for which the push operation is active, the priority attraction-in status is determined in correspondence with all the symbol positions “0”˜“20”, as described above, and the determined priority attraction-in status s are stored in the expected display combination storing area, as shown in FIG. 32B.

FIG. 32B is a storing example of the expected display combination storing area after the first stop operation is carried out for the left reel 3L. The expected display combination storing area 1 corresponds to the center reel 3C, and the expected display combination storing area 2 corresponds to the right reel 3R.

(Second Stop Operation)

Hereinafter, it will be described a case that a second stop operation is carried out with regard to the center stop button 7C and the symbol counter is “1” when the corresponding center stop button 7C is pushed.

First, in the reel stop control process, since the center stop button 7C is pushed when the symbol counter is “1”, the corresponding number of sliding symbols “3” is sampled from the stop table for the MB gaming state.

Next, in the priority attraction-in control process, since the second stop operation is the push operation for the center stop button 7C, the expected display combination storing area 1 is selected.

Next, in the control range retrieving process, the maximum possible number of sliding symbols “5” is set as the number of checks. It is obtained priority attraction-in status s (except the stop prohibition) as the number of checks from the address (symbol position “1” corresponds to it) of the expected display combination storing area 1 corresponding to the symbol counter “1” in an address order and the highest priority attraction-in status is retrieved. Herein (see FIG. 32B), “00000010” of the symbol position “3” and the symbol position “4” is the highest priority attraction-in status and is determined as the expected display combination data.

Since the determined expected display combination data and the priority attraction-in status corresponding to the symbol position “1” are not identical, the number of checks is subtracted by 1 and the address of the expected display combination storing area 1 is advanced by one.

Then, it is obtained a priority attraction-in status corresponding to the symbol position “2”, wherein the state obtained is not identical to the determined expected display combination data, the number of checks is subtracted by 1 and the address of the expected display combination storing area 1 is advanced by one.

Then, since the priority attraction-in status corresponding to the symbol position “3” and the expected display combination data are identical, it is taken a logical sum of the display combination (i.e., “00000110”) and the evacuated data (initial value is “0”) and a result thereof (i.e., “00000110”) is evacuated. Then, since it is taken an exclusive logical sum of the evacuated data and the display combination and a result thereof becomes “0”, the number of checks is subtracted by 1 and the address of the expected display combination storing area 1 is advanced by one.

Subsequently, since the priority attraction-in status corresponding to the symbol position “4” and the expected display combination data are identical, it is taken a logical sum of the display combination (i.e., “00000110”) and the evacuated data (i.e., “00000110”) and a result thereof (i.e., “00000110”) is evacuated. Since it is taken an exclusive logical sum of the evacuated data and the display combination and a result thereof becomes “0”, the number of checks is subtracted by 1 and the address of the expected display combination storing area 1 is advanced by one.

Since the priority attraction-in status corresponding to the symbol position “5” and the expected display combination data are not identical, the number of checks is subtracted by 1 and becomes “0” and the control range retrieving process is over (in addition, it is not performed an update of the maximum possible number of sliding symbols).

Next, in the priory attraction-in control process, it is referred to the number of sliding symbols “3” sampled from the stop table for the MB gaming state, and the retrieval order table, so that the proper number of sliding symbols is retrieved in retrieval order based on the corresponding sampled number of sliding symbols “3” (i.e., “3”→“1”→“0”→“2”→“4”).

Herein, with regard to the symbol positions “3” and “4”, the priority attraction-in data identical to the expected display combination data is stored. The symbol position “3” having the higher retrieval order is determined as the number of sliding symbols and an expected stop position (i.e., “4”) is determined on the basis of it.

As a result of that, the rotation of the center reel 3C is stopped on the basis of the expected stop position “4”, so that Replay, Bell and Watermelon are displayed on the upper, center and lower parts of the center display window 4C, respectively.

(After Second Stop Operation)

When the rotations of the left reel 3L and the center reel 3C are stopped, with regard to the right reel 3R corresponding to the stop button for which the push operation is active, the priority attraction-in status is determined in correspondence with all the symbol positions “0”˜“20”, as described above, and the determined priority attraction-in status is stored in the expected display combination storing area, as shown in FIG. 32C.

FIG. 32C is a storing example of the expected display combination storing area after the first stop operation is carried out for the left reel 3L and the second stop operation is carried out for the center reel 3C. The expected display combination storing area 1 corresponds to the right reel 3R.

(Third Stop Operation)

Hereinafter, it will be described a case that a third stop operation is carried out with regard to the right stop button 7R and the symbol counter is “1” when the corresponding right stop button 7R is pushed.

First, in the reel stop control process, since the right stop button 7R is pushed when the symbol counter is “1”, the corresponding number of sliding symbols “0” is sampled from the stop table for the MB gaming state.

Next, in the priority attraction-in control process, since the third stop operation is the push operation for the right stop button 7R, the expected display combination storing area 1 is selected.

Next, in the control range retrieving process, the maximum possible number of sliding symbols “5” is set as the number of checks. It is obtained priority attraction-in status s (except the stop prohibition) as the number of checks from the address (symbol position “1” corresponds to it) of the expected display combination storing area 1 corresponding to the symbol counter “1” in an address order and the highest priority attraction-in status is retrieved. Herein (see FIG. 32C), “00000001” of the symbol position “2” and the symbol position “3” is the highest priority attraction-in status and is determined as the expected display combination data.

Since the determined expected display combination data and the priority attraction-in status corresponding to the symbol position “1” are not identical, the number of checks is subtracted by 1 and the address of the expected display combination storing area 1 is advanced by one.

Then, since the priority attraction-in status corresponding to the symbol position “2” and the expected display combination data are identical, it is taken a logical sum of the display combination (i.e., “00000100”) and the evacuated data (initial value is “0”) and a result thereof (i.e., “00000100”) is evacuated. Then, since it is taken an exclusive logical sum of the evacuated data and the display combination and a result thereof becomes “0”, the number of checks is subtracted by 1 and the address of the expected display combination storing area 1 is advanced by one.

Subsequently, since the priority attraction-in status corresponding to the symbol position “3” and the expected display combination data are identical, it is taken a logical sum of the display combination (i.e., “00000010”) and the evacuated data (i.e., “00000100”) and a result thereof (i.e., “00000110”) is evacuated.

It is taken an exclusive logical sum of the evacuated data and the display combination. At this time, since a result thereof is not “0”, the maximum possible number of sliding symbols, i.e., “5” is subtracted by the number of checks at present time, i.e., “3”, and the maximum possible number of sliding symbols is updated to the result, i.e., “2” and then stored in the maximum possible number of sliding symbols storing area.

If an expected stop position is determined on the basis of the number of sliding symbols “2”, it is obstructed to determine an expected stop position (more specifically, expected stop position “2” based on the number of sliding symbols “1”), which is nearer at the timing at which the stop operation by the player is carried out (more strictly speaking, the symbol position corresponding to the symbol counter when the stop operation is carried out) and at which a combination of proper symbols can be displayed on the basis of the determined internal winning combination. Accordingly, in this embodiment, an update of the maximum possible number of sliding symbols is carried out so as to prevent the above situation from occurring, thereby reflecting a player's skill more correctly.

Next, in the priority attraction-in control process, it is referred to the number of sliding symbols “0” sampled from the stop table for the MB gaming state, and the retrieval order table, so that the proper number of sliding symbols is retrieved in retrieval order based on the corresponding sampled number of sliding symbols “0” (i.e., “0”→“2”→“4”→“1”→“3”).

First, the priority attraction-in status (i.e., “00000000”) corresponding o the symbol position “1”, which is obtained on the basis of the number of sliding symbols “0” having a retrieval order “1”, is not identical to the expected display combination data.

Subsequently, the priority attraction-in status (i.e., “00000001”) corresponding to the symbol position “3”, which is obtained on the basis of the number of sliding symbols “2” having a retrieval order “2”, is identical to the expected display combination data. However, since the obtained number of sliding symbols “2” is greater than a value (i.e., “1”) obtained by subtracting 1 from the maximum possible number of sliding symbols “2”, the expected stop position is not determined on the basis of the corresponding number of sliding symbols “2” and 1 is added to the retrieval order so as to check whether another number of sliding symbols is proper or not.

Then, the priority attraction-in status (i.e., “00000000”) corresponding to the symbol position “5”, which is obtained on the basis of the number of sliding symbols “4” having a retrieval order “3”, is not identical to the expected display combination data.

Subsequently, the priority attraction-in status (i.e., “00000001”) corresponding to the symbol position “2”, which is obtained on the basis of the number of sliding symbols “1” having a retrieval order “4”, is identical to the expected display combination data. Since the obtained number of sliding symbols “1” is not greater than a value (i.e., “1”) obtained by subtracting 1 from the maximum possible number of sliding symbols “2”, the corresponding obtained number of sliding symbols “1” is determined as the number of sliding symbols and the expected stop position “2” is determined on the basis of it.

As a result of that, the rotation of the right reel 3R is stopped on the basis of the expected stop position “2”, so that Blue 7, Bell and Watermelon are displayed on the upper, center and lower parts of the right display window 4R, respectively. Accordingly, the rotations of all the reels 3L, 3C, 3R are stopped, so that “Watermelon-Watermelon-Watermelon” is displayed on the bottom line 8d and a winning of Watermelon is determined.

As described above, in the gaming machine 1 of the embodiment, for all symbol positions “0”→“02” arranged on the periphery of each reel (in other words, for the symbols of the symbol positions “0”→“20”), the priority attraction-in ranking (i.e., priority attraction-in status) is determined on the basis of the type of the corresponding symbol, the types of symbols adjacent to the corresponding symbol and the type of the determined internal winning combination, and stored in the expected display combination storing area. In other words, by referring to the expected display combination storing area, it is possible to carry out a relative evaluation between the symbols arranged on the periphery of each reel. As a result of that, it is possible to properly reflect the internal lottery result.

In addition, for all symbols arranged on the periphery of each reel (in other words, for the symbols of the symbol positions “0”→“20”), since it is referred to the types of symbols adjacent to the corresponding symbol as well as the type of the corresponding symbol, it is possible to determine more detailed priority attraction-in ranking, as compared to determine the priority attraction-in ranking on the basis of a type of a single symbol. In addition, based on the priority attraction-in ranking table defining a priority ranking corresponding to the type of the internal winning combination, a priority attraction-in ranking is determined every symbol of the reel. Accordingly, it has only to update the priority ranking defined in the priority attraction-in ranking table so as to cope with an update of a machine.

If the detection of stop operation is carried out, the number of sliding symbols is obtained on the basis of the symbol counter (i.e., stop starting position) at that time and the stop table. In addition, it is determined the highest priority attraction-in ranking among the predetermined number of symbols (i.e., two of 0 and 1 if it is the left reel 3L under MB gaming state, and five of 0˜4 except it) from the stop starting position on the basis of the determined internal winning combination. The priority attraction-in ranking of the symbol based on the obtained number of sliding symbols (i.e., the symbol of the symbol position having added the corresponding number of sliding symbols to the stop starting position) and the priority attraction-in ranking determined to be highest are compared. As a result of the comparison, if the priority attraction-in ranking of the symbol based on the corresponding number of sliding symbols is same as the priority attraction-in ranking determined to be highest, the rotation of the reel is stopped on the basis of the corresponding number of sliding symbols. Otherwise, the rotation of the reel is stopped on the basis of the number of sliding symbols corresponding to the symbol having the priority attraction-in ranking determined to be highest.

In other words, even though the priority attraction-in ranking of the symbol based on the number of sliding symbols defined in the stop table is not highest, it is possible to stop the rotation of the reel, based on the number of sliding symbols corresponding to the symbol having the highest priority attraction-in ranking. Accordingly, it is possible to check whether the number of sliding symbols obtained on the basis of the stop table is inappropriate or not, thereby allowing the inappropriate number of sliding numbers not to be determined. As a result of that, it is possible to properly reflect the internal lottery result or a player's skill. In addition, even if the number of sliding symbols defined in the stop table is inappropriate, it is allowed, so that it is possible to reduce a development burden of checking a stop table prepared.

In addition, in the embodiment, in accordance with the retrieval order based on the number of sliding symbols sampled from the stop table, it is obtained the respective number of sliding symbols of a predetermined range (i.e., two of 0 and 1 if it is the left reel 3L under MB gaming state, and five of 0˜4 except it) from the stop starting position, and it is compared the priority attraction-in ranking of the symbol (i.e., the symbol of the symbol position having added the corresponding number of sliding symbols to the stop starting position) and the priority attraction-in ranking determined to be highest. Accordingly, even when there are the plural same priority attraction-in rankings in the symbols depending on the number of sliding symbols of the predetermined range, it is possible to stop the rotation of the reel based on a single number of sliding symbols having a higher retrieval order.

Additionally, the retrieval order table defines the retrieval order of the number of sliding symbols sampled from the stop table to be highest. In other words, it is preferentially carried out the comparison of the priority attraction-in ranking of the symbols based on the number of sliding symbols sampled from the stop table and the priority attraction-in ranking determined to be highest. Accordingly, if the priority attraction-in ranking of the symbols based on the number of sliding symbols sampled from the stop table is same as the highest priority attraction-in ranking, even though the number of sliding symbols having the priority attraction-in ranking same as it exists within the predetermined range, the number of sliding symbols sampled from the stop table takes the priority, and it is possible to stop the rotation of the reel based on the number of sliding symbols sampled from the stop table. As a result of that, it is possible to preferentially display the symbol intended in the development.

In addition, in the embodiment, when the detection of the stop operation is carried out, it is retrieved the number of sliding symbols at which a display of a symbol relating to the internal winning combination determined is obstructed, among the number of sliding symbols of the predetermined range, and the corresponding retrieved number of sliding symbols is determined as the maximum possible number of sliding symbols. In case that the priority attraction-in ranking of the symbol based on the number of sliding symbols obtained on the basis of the stop starting position, the stop table and the retrieval order table is same as the priority attraction-in ranking determined to be highest, the corresponding number of sliding symbols and the maximum possible number of sliding symbols are compared. As a result of the comparison, if the corresponding number of sliding symbols is smaller than the maximum possible number of sliding symbols, the rotation of the reel is stopped on the basis of it. In other words, with regard to the number of sliding symbols determined to have the highest priority attraction-in ranking of the symbol, it is checked whether or not the determined number of sliding symbols is the number of sliding symbols at which the display of symbols relating to the internal winning combination is obstructed. If it is not the number of sliding symbols at which the display of symbols relating to the internal winning combination is obstructed, the rotation of the reel is stopped on the basis of the corresponding number of sliding symbols. Accordingly, even though the corresponding number of sliding symbols is the number of sliding symbols determined to have the highest priority attraction-in ranking of the symbol, if the display of symbols relating to the internal winning combination is obstructed at the corresponding number of sliding symbols, the corresponding number of sliding symbols (i.e., inappropriate number of sliding symbols) is not determined. Thereby, it is possible to prevent the display of symbols relating to the internal winning combination from being obstructed.

Herein, “the obstruction of the display of symbols relating to the internal winning combination” is meant as follows: for example, in case that plural internal winning combinations are determined, as in the MB gaming state and when there are the symbol position capable of displaying the symbols relating to a one internal winning combination and the symbol position capable of displaying the symbols relating to another internal winning combination having the same priority attraction-in ranking as the symbols relating to the corresponding one internal winning combination, within the predetermined range of the number of sliding symbols from the stop starting position, it is not determined the number of sliding symbols (i.e., the smaller number of sliding symbols) from the stop starting position to the nearer symbol position, but the number of sliding symbols (i.e., the greater number of sliding symbols) from the stop starting position to the farther symbol position, among the above symbol positions, and the rotation of reel is stopped on the basis of it.

Accordingly, since it is avoided the obstruction of display of the symbols relating to the internal winning combination and thus the rotation of the reel is stopped at the symbols relating to the internal winning combination existing at the symbol position nearer at the stop starting position, it is possible to prevent the rotation of the reel from being stopped at the symbols relating to the another internal winning combination farther from the stop starting position beyond the symbol relating to the internal winning combination nearer at the stop starting position and thus to properly reflect the player's skill.

In the embodiment, it is checked whether the number of sliding symbols obtained from the predetermined range is the inappropriate number of sliding symbols, according to the retrieval order based on the number of sliding symbols defined in the stop table, and it is not allowed the rotation of the reel to be stopped on the basis of the inappropriate number of sliding symbols. The above mentioned method can be also applied to a gaming machine having no stop table and the same effects can be also achieved. For example, even for a gaming machine structured to obtain the number of sliding symbols on the basis of a retrieval table defining a predetermined retrieval order (e.g., 0 symbol→1symbol→2symbol→3symbol→4symbol) and a gaming machine provided with a plurality of retrieval order tables and structured to obtain the number of sliding symbols on the basis of a one retrieval order table determined for each symbol arranged on the periphery of the reel, it is carried out a check based on the priority attraction-in ranking and the maximum possible number of sliding symbols, with regard to the obtained number of sliding symbols, as described above, so that it is not determined the inappropriate number of sliding symbols.

While the embodiment has been described, the invention is not limited thereto.

In addition, regarding the reel, the start operation detection means, the internal winning combination determination means, the reel rotation means, the stop operation detection means, the symbol specifying means, the stop table memory means, the means for obtaining the number of sliding symbols, the priority ranking determination means, the reel stop means, the means for memorizing retrieval order table, the means for the maximum possible number of sliding symbols and the like, which constitute the gaming machine, the specific structures thereof are not limited to each element described in the above embodiment and can be changed.

In the above embodiment, it is structured such that the priority attraction-in status has the higher priority attraction-in ranking as the upper bit is ON (i.e., the greater the value) and the symbol position determined to have the highest value as the priority attraction-in status is a symbol having the highest priority attraction-in ranking. However, the invention is not limited thereto and a structure of the priority attraction-in status can be arbitrarily modified. In other words, it may be structured such that the lower bit is ON (i.e., the smaller the value), the higher the priority attraction-in ranking. In addition, the symbol position determined to have the smallest value as the priority attraction-in ranking data may be a symbol having the highest priority attraction-in ranking.

Further, the structure of the machine shown in FIGS. 1 and 2, the circuit structure shown in FIG. 3 and the peripheral device thereof, the structures of the tables shown in FIGS. 4 to 13, the structures of the storing areas of the RAM shown in FIGS. 14 to 17, the flow charts shown in FIGS. 19 to 30 and the like, which has been applied to the above embodiment, can be arbitrarily changed or modified without departing a spirit of the invention.

In addition, in addition to the pachi-slot machine as described in the embodiment, the invention can be applied to another gaming machine such as slot machine, pachinko gaming machine, arrange ball, jankyu (combination of pachinko and mahjong) gaming machine, video slot, video poker and the like. Additionally, the invention can be applied to a game program which pseudo-executes the operations of the above pachi-slot machine as a home gaming machine, thereby executing a game. In this case, a medium for recording the game program may include a CD-ROM, FD (flexible disk) and the other recording media.

In addition, the effects described in the embodiment are only enumerations of the most preferred effects obtainable from the invention and the effects of the invention are not limited to the embodiments.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
a reel having a plurality of symbols arranged on a periphery thereof and displaying the plural symbols;
start operation detection means for detecting a start operation;
internal winning combination determination means for determining an internal winning combination, on the basis of the detection of the start operation carried out by the start operation detection means;
reel rotation means for rotating the reel;
stop operation detection means for detecting a stop operation;
symbol specifying means for specifying a symbol located on a predetermined position;
stop table memory means for memorizing a stop table defining the number of sliding symbols for each of symbols arranged on the periphery of the reel;
means for obtaining the number of sliding symbols, on the basis of the symbol specified by the symbol specifying means and the stop table memorized by the stop table memory means, when the detection of the stop operation is carried out by the stop operation detection means;
priority ranking determination means for determining the highest priority attraction-in ranking among a predetermined number of symbols from the symbols specified by the symbol specifying means, on the basis of the internal winning combination determined by the internal winning combination means, when the detection of the stop operation is carried out by the stop operation detection means; and
reel stop means for stopping the rotation of reel on the basis of the number of sliding symbols obtained by the means for obtaining the number of sliding symbols, when a priority attraction-in ranking of the symbol based on the number of sliding symbols obtained by the means for obtaining the number of sliding symbols is same as the priority attraction-in ranking determined by the priority ranking determination means, and for stopping the rotation of reel on the basis of the number of sliding symbols corresponding to the symbol of the priority attraction-in ranking determined by the priority ranking determination means, when a priority attraction-in ranking of the symbol based on the number of sliding symbols obtained by the means for obtaining the number of sliding symbols is not same as the priority attraction-in ranking determined by the priority ranking determination means.

2. The gaming machine according to claim 1, wherein further comprising means for memorizing a retrieval order table defining a retrieval order according to each number of sliding symbols of a predetermined range, based on the number of sliding symbols defined by the stop table,
wherein the means for obtaining the number of sliding symbols obtains the number of sliding symbols on the basis of the symbol specified by the symbol specifying means, the stop table memorized by the stop table memory means and the retrieval order table memorized by the retrieval order table memory means, when the detection of the stop operation is carried out by the stop operation detection means, and
wherein the retrieval order table defines a retrieval order of the number of sliding symbols defined by the stop table to be highest.

3. The gaming machine according to claim 1, further comprising maximum possible number of sliding symbols determination means for determining the number of sliding symbols at which a display of a symbol relating to the internal winning combination determined by the internal winning combination determination means is obstructed, among the number of sliding symbols of the predetermined range, as a maximum possible number of sliding symbols, when the detection of the stop operation is carried out by the stop operation detection means,
wherein the reel stop means stops the rotation of reel on the basis of the number of sliding symbols obtained by the means for obtaining the number of sliding symbols, when the priority attraction-in ranking of the symbol based on the number of sliding symbols obtained by the means for obtaining the number of sliding symbols is same as the priority attraction-in ranking determined by the priority ranking determination means and the number of sliding symbols obtained by the means for obtaining the number of sliding symbols is smaller than the maximum possible number of sliding symbols determined by the maximum possible number of sliding symbols determination means.

4. A gaming machine comprising:
a reel having a plurality of symbols arranged on a periphery thereof and displaying the plural symbols;
start operation detection means for detecting a start operation;
internal winning combination determination means for determining an internal winning combination, on the basis of the detection of the start operation carried out by the start operation detection means;
reel rotation means for rotating the reel;
stop operation detection means for detecting a stop operation;
symbol specifying means for specifying a symbol located on a predetermined position;
priority ranking determination means for determining the highest priority attraction-in ranking among a the predetermined number of symbols from the symbols specified by the symbol specifying means, on the basis of the internal winning combination determined by the internal winning combination means, when the detection of the stop operation is carried out by the stop operation detection means;
maximum possible number of sliding symbols determination means for determining the number of sliding symbols at which a display of a symbol relating to the internal winning combination determined by the internal winning combination determination means, among the numbers of sliding symbols of a predetermined range, is obstructed, as the maximum possible number of sliding symbols, when the detection of the stop operation is carried out by the stop operation detection means; and
means for obtaining one of the numbers of sliding symbols of the predetermined range, according to a predetermined retrieval order,
wherein when a priority attraction-in ranking of the symbol based on the number of sliding symbols obtained by the means for obtaining the number of sliding symbols is same as the priority attraction-in ranking determined by the priority ranking determination means and the number of sliding symbols obtained by the means for obtaining the number of sliding symbols is smaller than the maximum possible number of sliding symbols determined by the maximum possible number of sliding symbols determination means, the rotation of reel is stopped on the basis of the number of sliding symbols obtained by the means for obtaining the number of sliding symbols.
